(19) United States
(12) Patent Application Publication
(10) Pub. No.: US 2007/0219826 A1
(43) Pub. Date: Sep. 20, 2007

(54) METHOD AND SYSTEM FOR PATIENT INFORMATION PROCESSING AND MANAGEMENT

(75) Inventors: Peris L. Brodsky, Riverwoods, IL (US); Timothy J. Coburn, Palos Park, IL (US); Susan L. McBride, Palatine, IL (US)

Correspondence Address: SACHNOFF & WEAVER, LTD., 10 SOUTH WACKER DRIVE, CHICAGO, IL, 60606-7507, US

(73) Assignee: Information Data Management, Inc., Rosemont, IL (US)

(21) Appl. No.: 11/620,384

(22) Filed: Jan. 5, 2007

Related U.S. Application Data
(60) Provisional application No. 60/805,714, filed on Jun. 23, 2006.
(60) Provisional application No. 60/783,434, filed on Mar. 17, 2006.

(51) Int. Cl. G06Q 10/00; G06F 19/00; G06Q 50/00

(52) U.S. Cl. 705/2; 705/3

(57) ABSTRACT

A donor processing and information management system disclosed herein allows donor processing centers to facilitate their operations and decrease the use of paperwork and forms by using electronic workstations to enter donor and donation information. Embodiments of the system also facilitate operations of the donor processing centers by automating the management of donors, thus reducing the number of staff necessary to run the center. Donors and donor center staff use workstations to enter biographical data, answer questions, and edit information entered into a database in order to reduce human error and increase efficiency. Thus, embodiments of the system may completely eliminate the use of burdensome forms and automate the entire blood donation process for donor processing centers, whether operating with in-line, real time hardware interfaces at a fixed location, or at mobile locations, where data is collected onsite and transmitted to one or more offsite databases.

### CROSS-REFERENCE TO RELATED APPLICATIONS

This application is based on and claims the benefit of U.S. Provisional Application Nos. 60/805,714, filed on Jun. 23, 2006 and entitled “Method and System for Blood Donor Processing and Information Management,” and U.S. Provisional Application No. 60/783,434, filed on Mar. 17, 2006 and entitled “Method and System for Blood Donor Processing and Information Management, all of which are incorporated herein by reference in its entirety.

### BRIEF DESCRIPTION OF THE DRAWINGS

While the appended claims set forth the features of the present patent with particularity, the patent, together with its objects and advantages, may be best understood from the following detailed description taken in conjunction with the accompanying drawings, of which:

FIG. 1 is a schematic diagram of the blood donor processing and information management system;

FIG. 2 is a schematic/block diagram of a used by the blood donor processing and information management system of FIG. 1;

FIG. 3 is an illustration of a typical keypad for entering data into input module;

FIG. 4 is a search result list responsive to input to the registration module of the present invention;

FIG. 5 is a sample display of a user's selected profile;

FIG. 6 is a sample of question text posed to the prospective donor through operation of the interview module;

FIG. 7 is an illustration of the multiple language capability of the interview module of the present invention;

FIG. 8 illustrates an embodiment of the invention that prevents a user of the interview module from skipping questions that may need to be answered;

FIG. 9A is an illustration of sample survey questions for response by a donor;

FIG. 9B is a logic diagram showing the decision tree used to determine a proper response regarding the donor's vital measurements and characteristics;

FIG. 10 is an illustration of the review module display allowing a staff member to edit a donor's responses;

FIG. 11 is an illustrative consent form to be signed by a donor using the digitizing pad shown in FIG. 2;

FIG. 12 is an illustration of a field screen for the input of optional donor characteristics into the vitals module of the present invention;

FIG. 13 is an illustration of a field screen allowing a staff member to make a second donor characteristic measurement set in the vitals module of the present invention;

FIG. 14 is an illustration of the screen shown to a staff member before a donation begins, with certain functions disabled, which functions may need to be enabled to begin the donation procedure;

FIG. 15A is an illustration of the screen of FIG. 14, showing the enablement of functions shown disabled in FIG. 14;

FIG. 15B is an illustration of a screen showing the division of the management module into stages of the donation process and the donor's current status;

FIG. 15C is an illustration of the screen presenting the staff with the first donor's record;

FIG. 15D is an illustration of the user-group sub-window showing a single selection list of all users or groups on the system;

FIG. 15 E is a list of possible waiting room statuses;

FIG. 15F is a list of workflow processes and resulting statuses;

FIGS. 16A and 16B are logic diagrams depicting two representative progressions in the donor screening process of the present invention;

FIG. 17 is an embodiment of a facility layout for using the present invention;

FIG. 18 is a logic diagram of a process occurring at the interview workstation;

FIG. 19 is a logic diagram of a process occurring at the review workstation;

FIG. 20 is a logic diagram illustrating a process of the vitals workstation;

FIG. 21 is a logic diagram illustrating a process of the donation workstation;

FIG. 22A is a schematic diagram of the data flow paths of the disclosed system; and

FIG. 22B is a diagram of the fixed and mobile site topology of the system of the present invention.

### DETAILED DESCRIPTION

### I. Embodiments of the System Overview

### A. In General

Illustrative embodiments of a Donor Processing and Information Management system are described herein with reference to the accompanying drawing figures. Embodiments of the system may be adapted for use in a variety of configurations to suit the needs of any donor processing facility. A person having ordinary skill in the art will recognize that the present embodiments may be practiced in a variety of manners without departing from the spirit and scope of the claimed subject matter.

Embodiments of the system allow donor processing centers to facilitate their operations and decrease the use of paperwork and forms by using electronic workstations to enter donor and donation information. Embodiments of the system also facilitate operations of the donor processing center by automating the management of donors, thus reducing the number of staff necessary to run the center. Donors and donor center staff use workstations 100 to enter biographical data, answer questions, and edit information entered into a database in order to reduce human error and increase efficiency. Thus, embodiments of this invention may completely eliminate the use of burdensome forms and automate the entire blood donation process for donor processing centers, whether operating with in-line, real time hardware interfaces at a fixed location, or at mobile locations, where data is collected onsite and transmitted to one or more offsite databases.

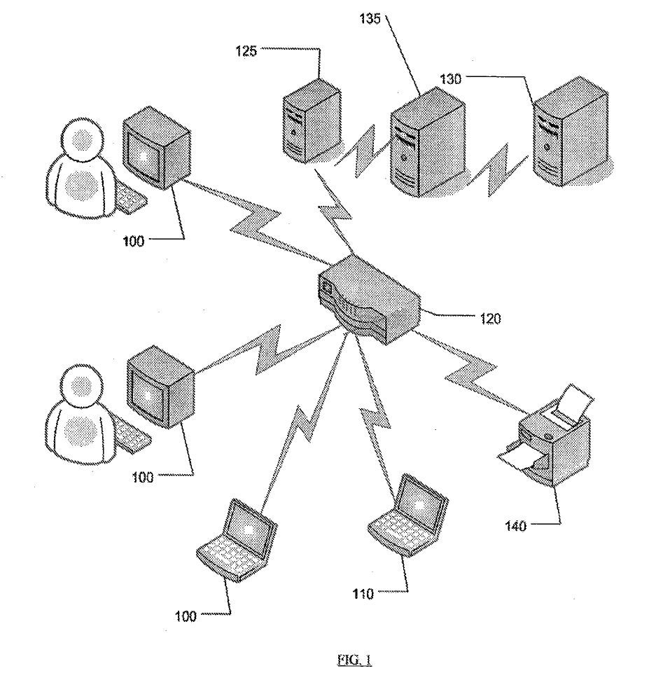

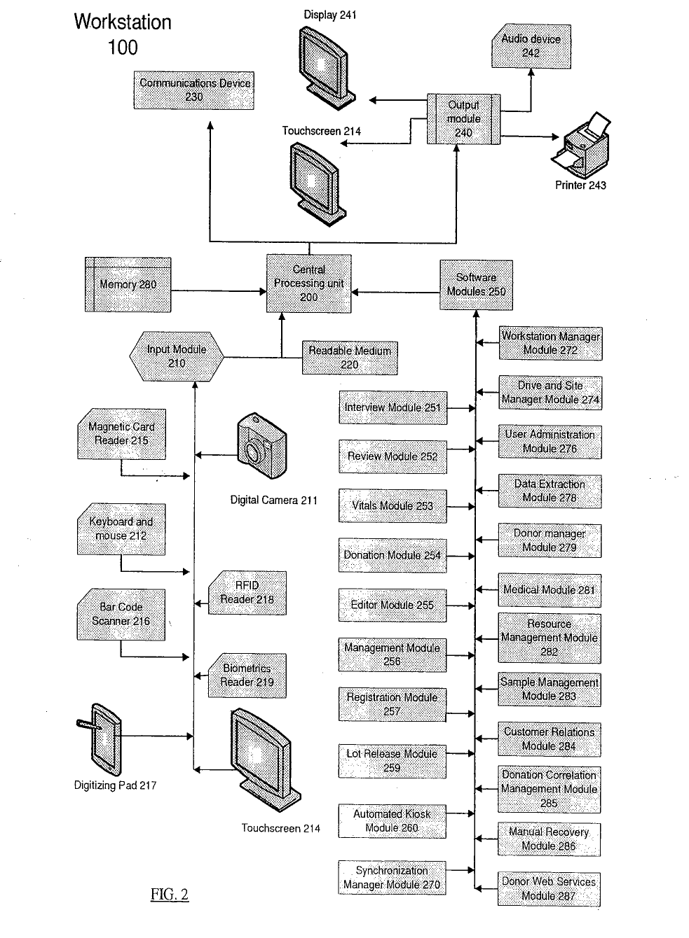

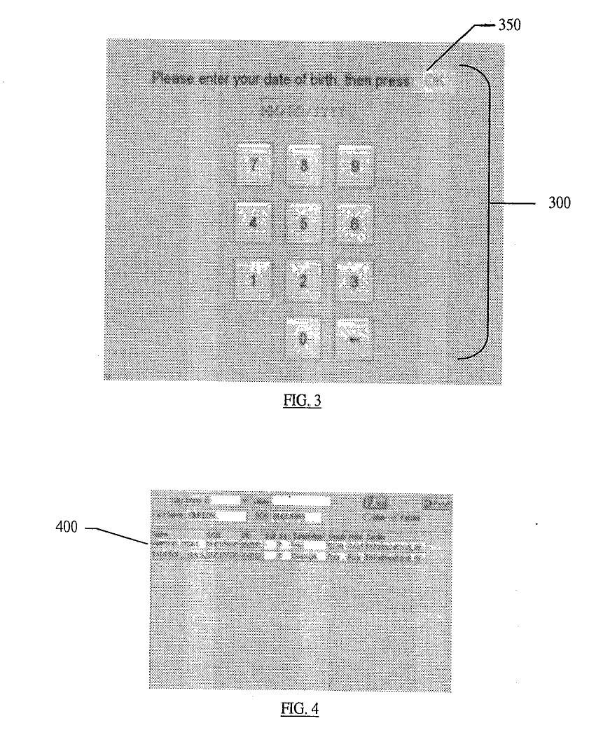

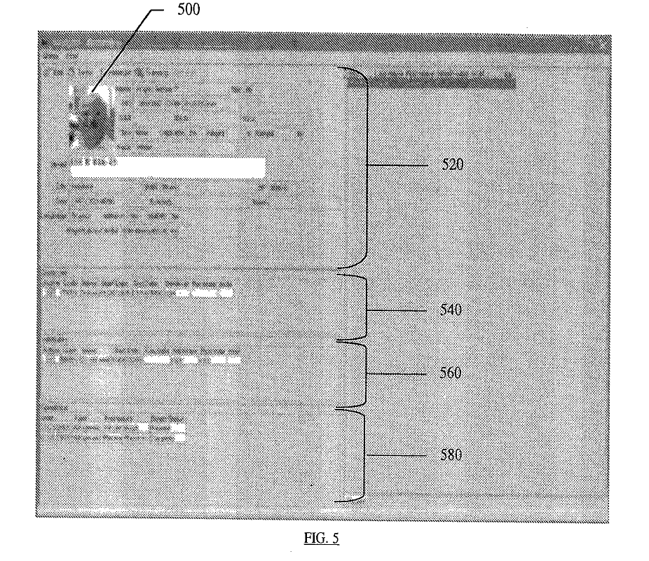

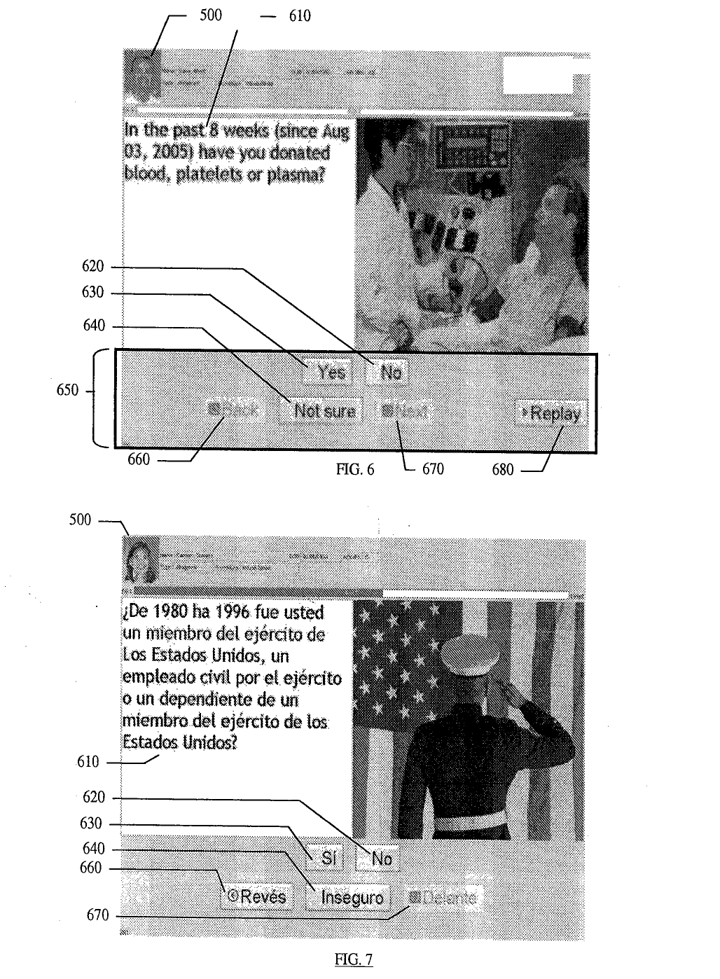

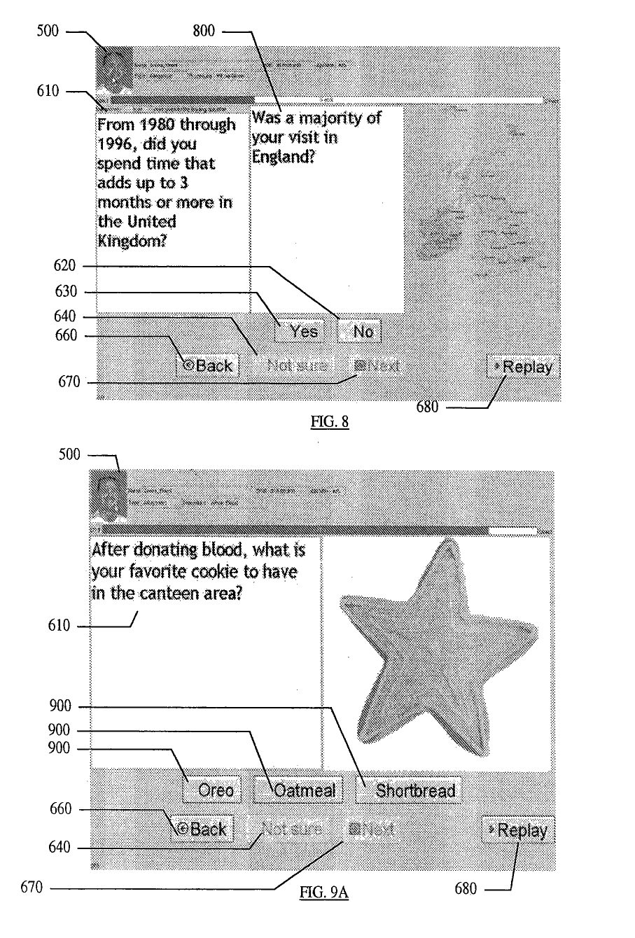

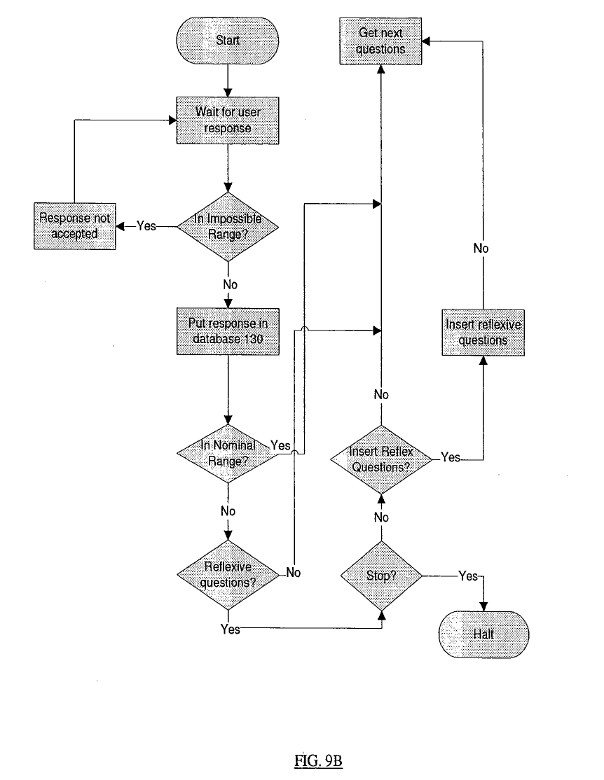

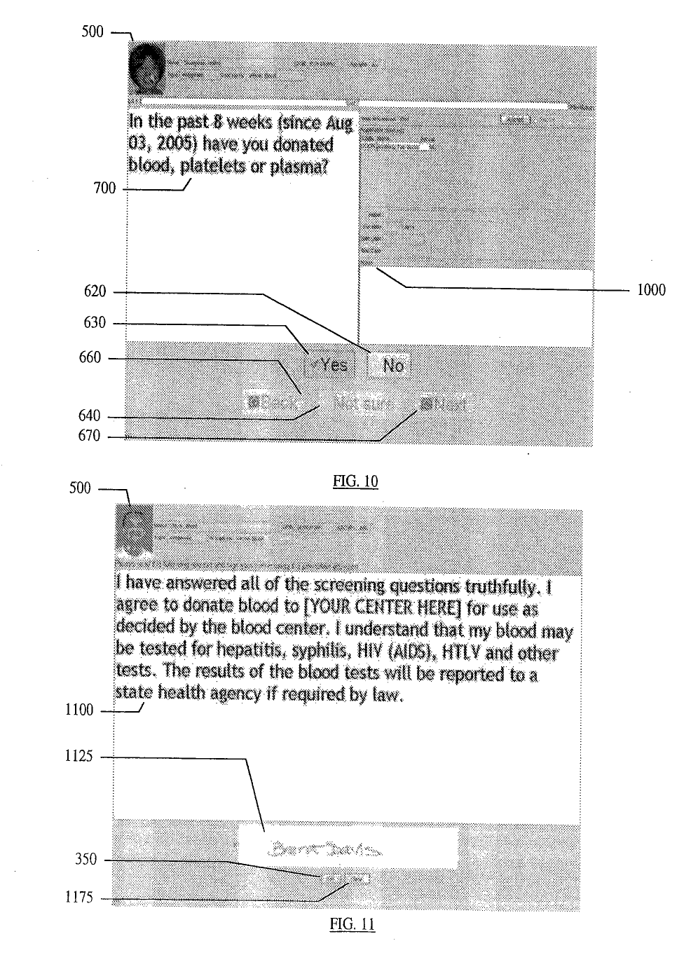

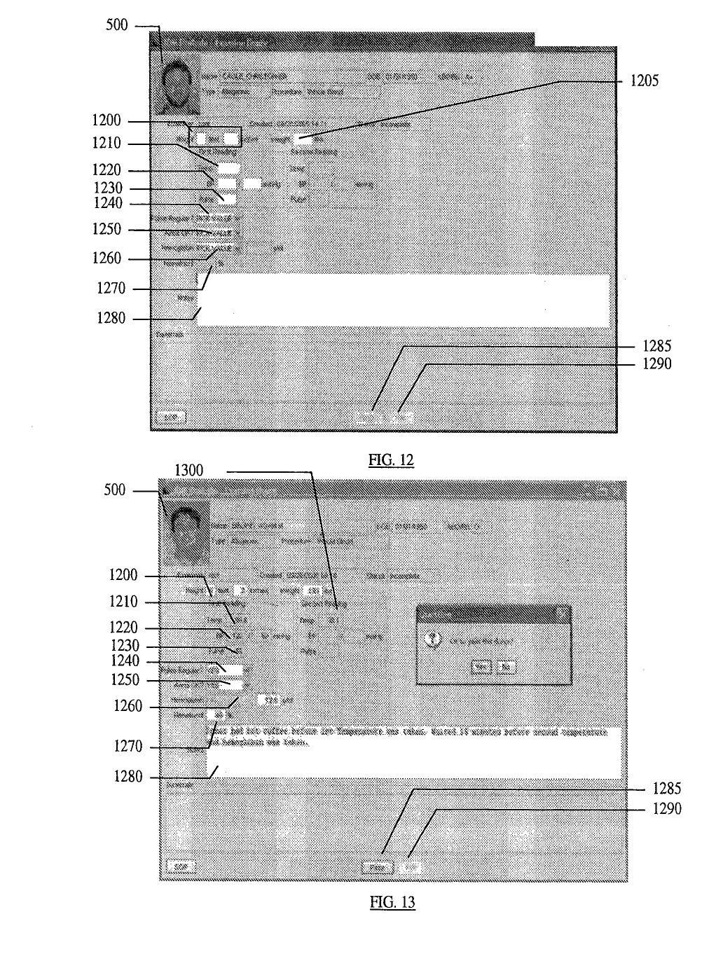

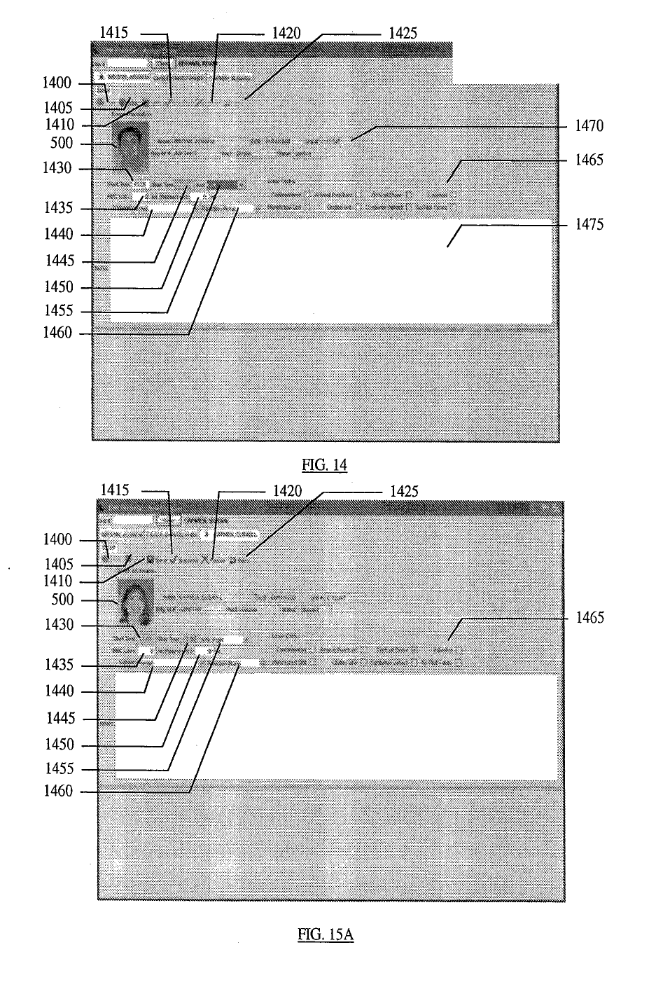

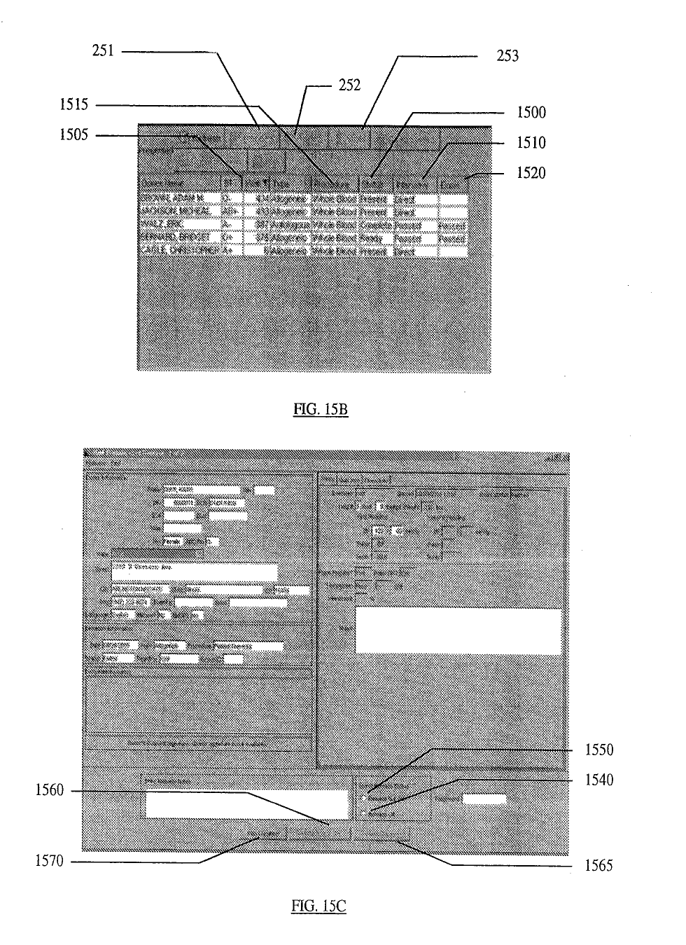

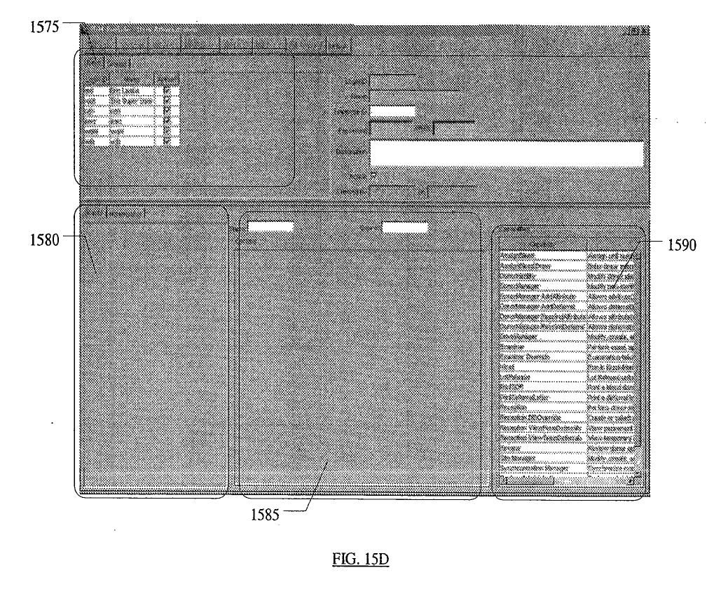

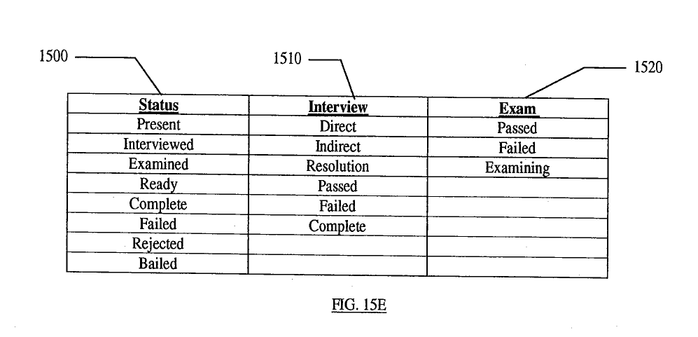

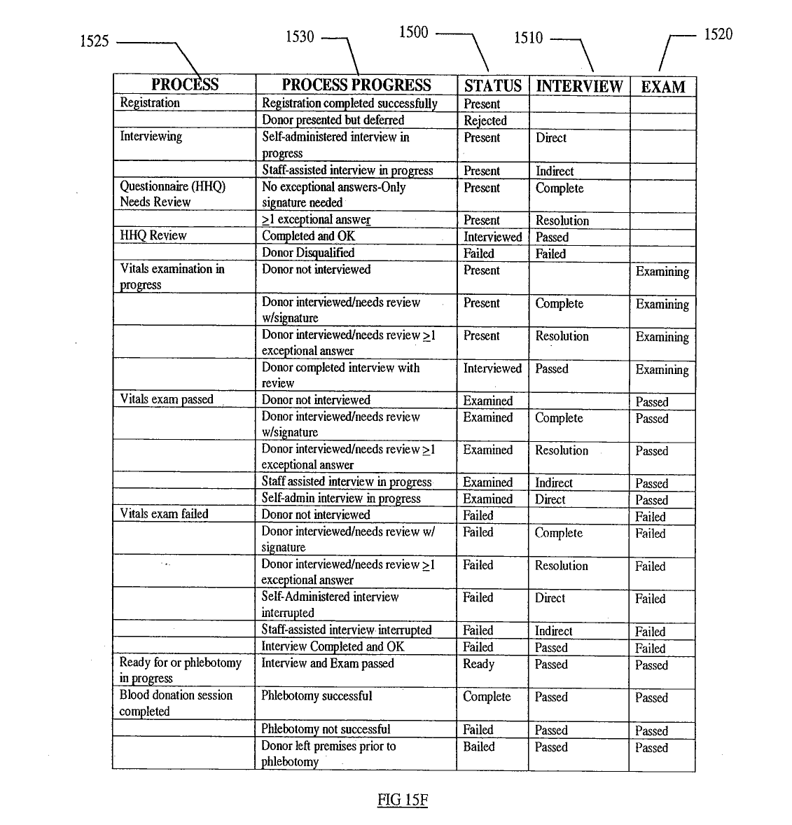

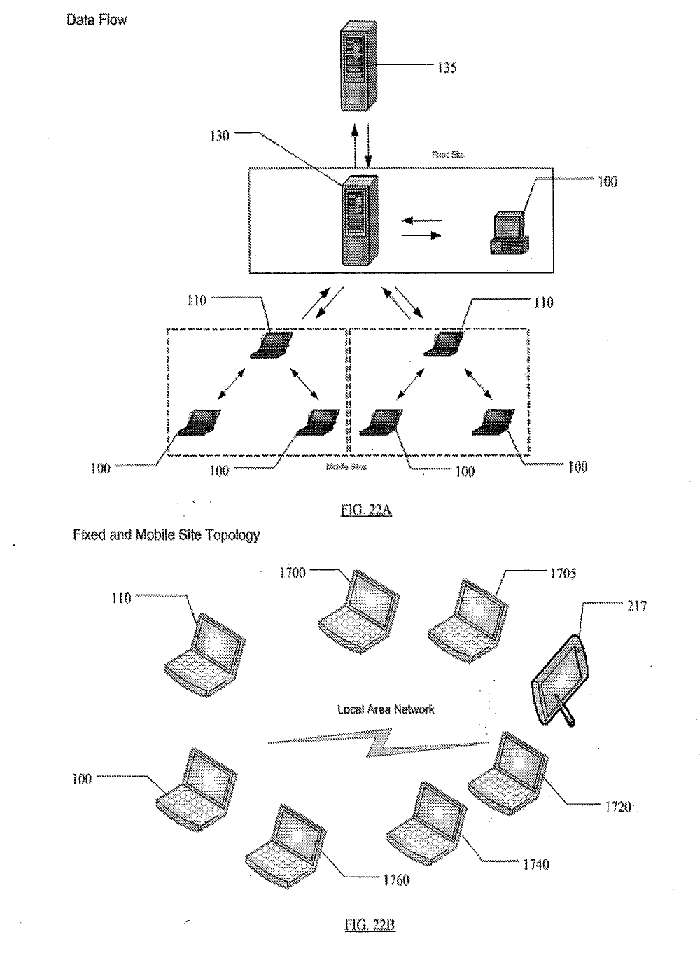

As best seen in FIG. 1, an embodiment of the donor system 10 consists of at least one workstation 100, a communications network 120, an application server 125, at least one database server 130, and at least one host database 135. The application server 125 interfaces with the at least one database server 130 and the database server 130 in turn interfaces with at least one host database 135. In another embodiment, additional database servers 130 may access the application server 125 off-line at a specific mobile operation. FIGS. 22A and 22B are alternate embodiments of FIG. 1 having alternate network topologies. One of skill in the art will appreciate that any number of topologies may be used, and that the application server 125, the database server 130, and the host database 135 may be operated using a single central processing unit, whether centralized or distributed.

The workstation 100, connected by the communications network 120, retrieves donor information contained in the database server 130. As the donor, or donor center staff, enters information, the information is transmitted across the communications network 120 and updated within the database server 130. Embodiments of the system may also contain at least one network printer 140 to print documents necessary to facilitate the operation of a donor facility.

The communications network 120 may be any of a plurality of alternative networks used for communicating or broadcasting data, such as a telecommunications network, LAN or WAN or combinations thereof. A computer network protocol is one example of an alternative for broadcasting and/or communicating data on a communications network, and one of skill in the art will appreciate that alternatively any wired or wireless communication network, such as digital cable, cellular protocols, or any number of communications services may be used.

### B. Workstation Description

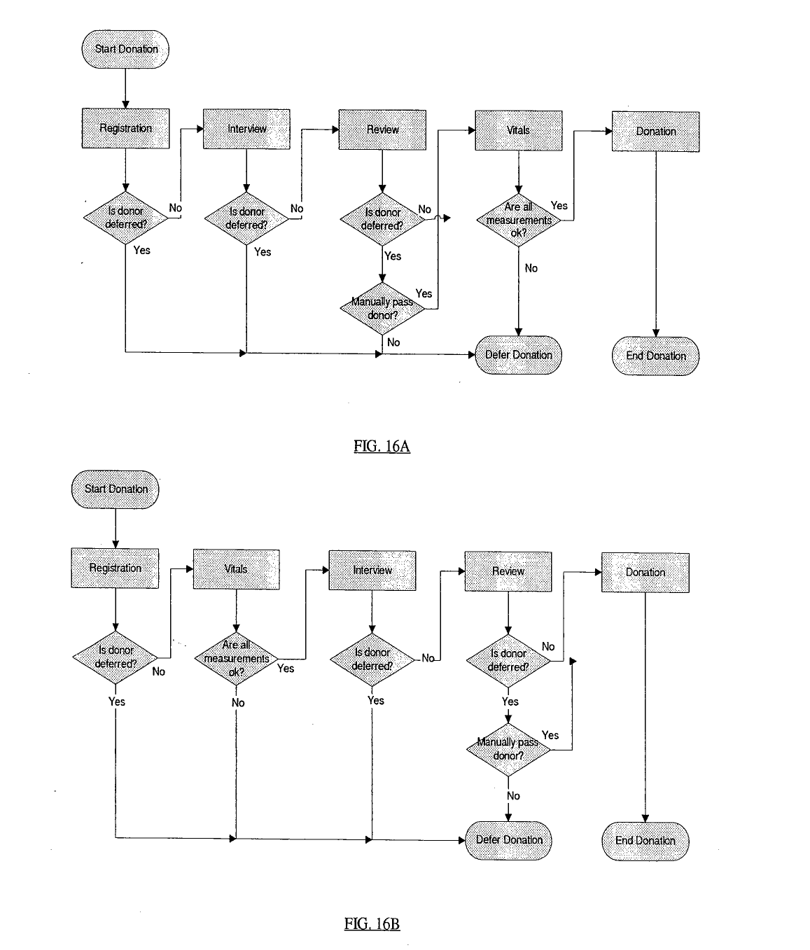

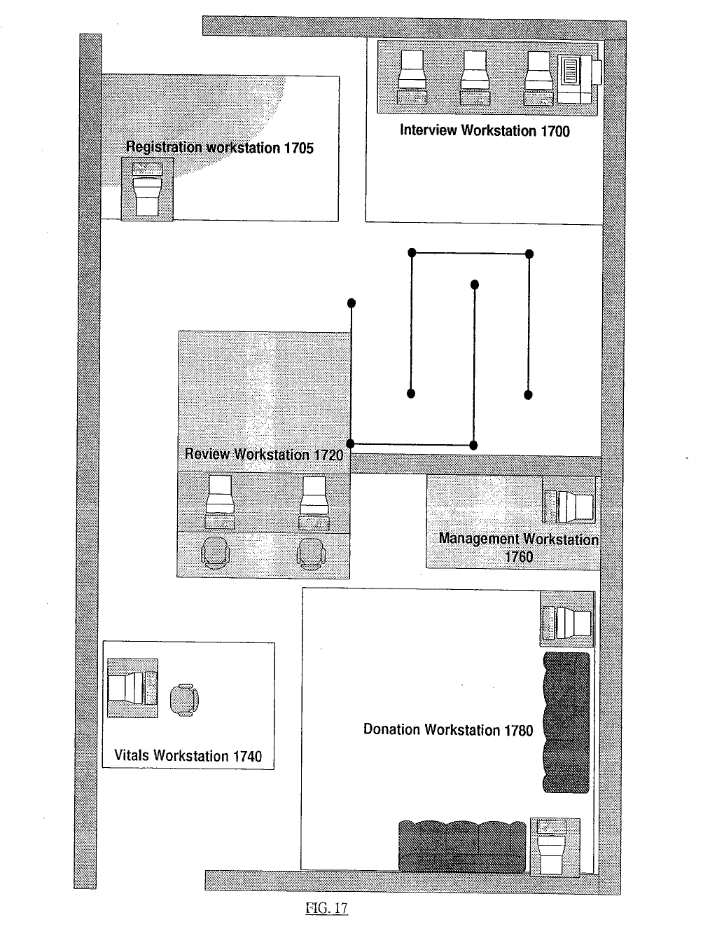

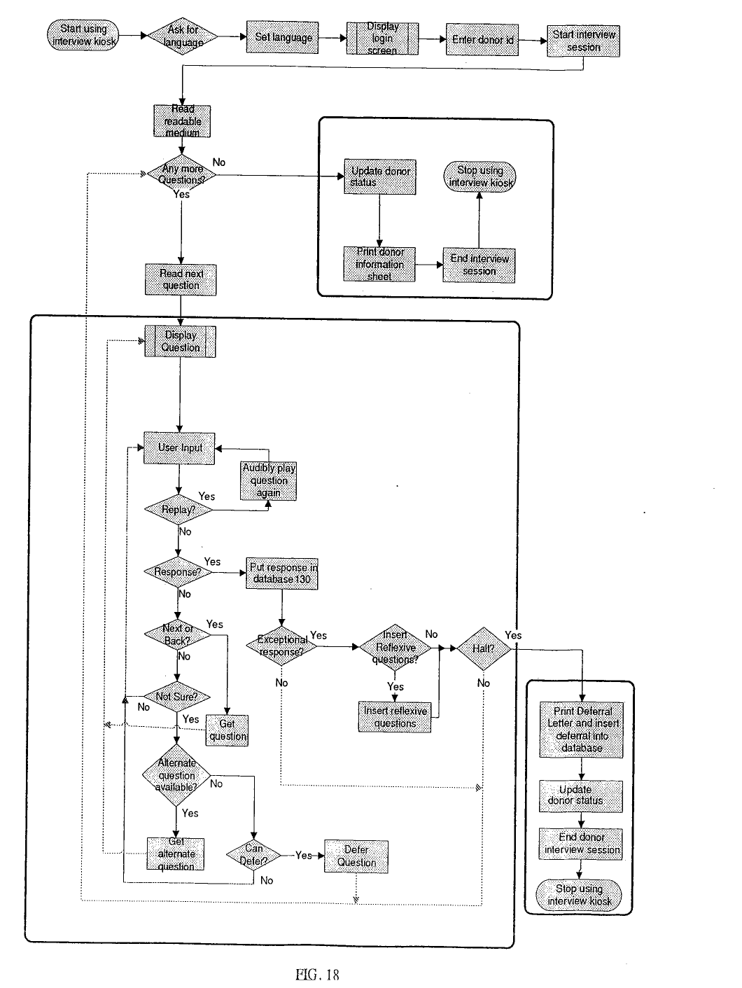

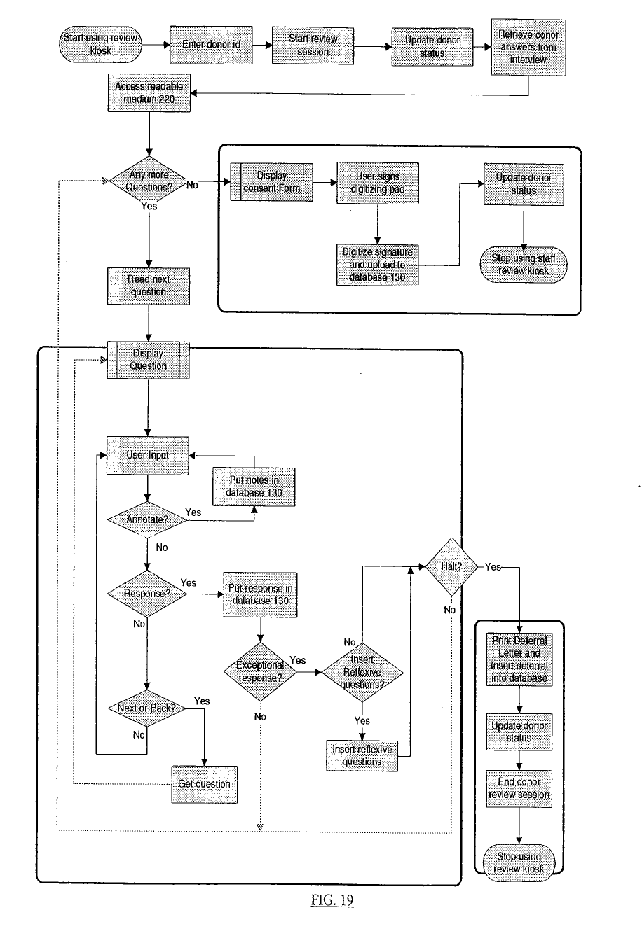

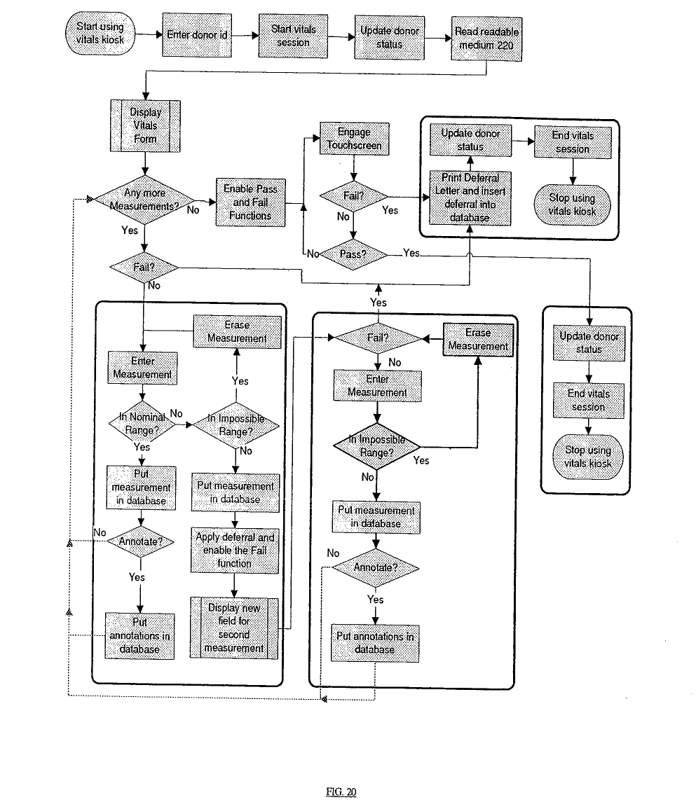

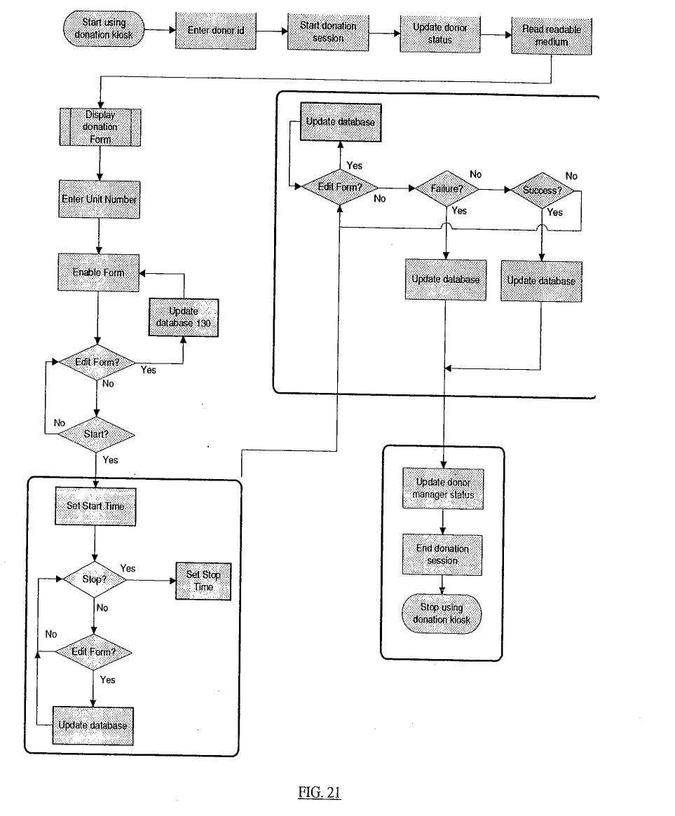

Now referring to FIG. 2, in an embodiment of the system 10 the workstation 100 is shown to generally consist of a central processing unit 200, a memory 280, a communications device 230, an input module 210 and an output module 240. The output module 240 comprises a display 241 capable of displaying graphics and text. In an alternate embodiment, the workstation 100 may be a portable device for entering data, accessing real time donation information and confirming a donor's identity prior to phlebotomy. In another embodiment, the workstation 100 may be configured as a kiosk that allows a donor to complete, for example, a self-administered, health history questionnaire in privacy. One of skill in the art will appreciate that the workstation 100 may be of any form of computing device and may further be configured to accommodate any number of different peripherals.

Peripherals of the workstation 100 may be internal or external and may further be shared on a network. The workstation 100 may be configured to use an audio device 242 to play audio (with a headphone option for the donor's privacy) back for the user. The audio may be stored in either a digital or analog medium. The workstation 100 may also be configured to use a printer 243 to print any items necessary to facilitate the donation process.

The input module 210 sends a donor's input to the central processing unit 200. The input module 210 may consist of a keyboard and mouse 212 or a touchscreen 214 technology for direct entry of information into the workstation 100. The input module 210 of the workstation 100 may also use a digitizing pad 217 to process handwritten information entered by the user. Embodiments of the system may also include alternate input modules 210 for inputting information using a digital camera 211 for recording pictures, a magnetic card reader 215 to read data that is magnetically stored on a card, a bar code scanner 216, an RFID reader 218 or a biometrics reader 219 any combination thereof.

### C. Software Modules

### 1. In General

Embodiments of the system 10 also include software modules 250 that may be executed by a workstation 100. Workstation 100 is used to manage donors, enter donor information into the system, interview donors and automate other tasks during the blood donation operation. Before interacting with the system 10, the donor must register using a registration module 257. Embodiments of the system may include an interview module 251 used for presenting questions and instructions to process a user's input, a review module 252, a vitals module 253, a donation module 254, and a lot release module 259. Staff notes can be documented in any of these modules. In addition, the donor may use the workstation 100 with an automated kiosk module 260. In one embodiment, the automated kiosk module 260 may operate the registration module 257 and the interview module 251. The review module 252 is used to ask additional questions and edit answers provided to the interview module 251. The vitals module 253 is used for the physical examination of the donor. The donation module 254 is for documenting the key data elements of the donation process. Finally, the lot release module 259 allows a user with specific capabilities to review all donations and to ensure the donation has adequate documentation to permit release.

In an embodiment of the system 10 the software modules 250, may also include additional modules used by the staff to facilitate the operation of donor facilities. One such module, a management module 256, allows a user to observe the status of all donors present at the donor center. Similarly, a user administration module 276, allows the user to view, edit, and retrieve any user records. An embodiment of this system may also contain a synchronization manager module 270 to update the information in the at least one database servers 130 or in at least one of multiple offline database servers 130.

In an alternate embodiment of the system 10, the software modules 250 may also include additional modules for use by the staff to facilitate the administration of donation operations. One such module is a donor manager module 279, which allows a staff user to view, edit and retrieve donor records of the donor center. Another module is an editor module 255, which allows the user to create, edit, and retrieve questions and instructions that are stored within a readable medium 220. Additionally, an embodiment of the system may also include a drive and site manager module 274, which provides a staff user various function specific capabilities and authorization to create parameters associated with the donation process.

Embodiments of the donor system 10 provide for the flexibility to incorporate numerous additional software modules 250. Other embodiments of the donor system employ a workstation manager module 272, which allows the user to create, deactivate and modify workstations 100 used by the system; a medical module 281, which allows a medical professional to document the physical examination of a donor resulting from an unexpected, adverse reaction to donation, or to document a more extensive annual physical examination required for certain types of donors. Additionally, the system 10 may also include a resource management module 282, which assists the staff with three routine operational tasks: inventory and equipment management, staff scheduling, and donor collection scheduling; a sample management module 283, which allows the staff to identify, track and verify the identity of donor pilot tube samples; a customer relations module 284, which allows the staff to reprint donor cards with a photograph, allows donations to be credited to a specific drive or sponsor at the donor's request, and assists the staff with donor recognition tasks by tracking donation volumes, and donors' birthdays; a donation correlation manager 285, which provides case management for directed and autologous blood donations; a manual recovery module 286, which provides the staff with backup manual batch entry functionality for paper documents should the system become unavailable, as in an equipment failure; and, a donor web services module 287, which allows donors to obtain their donation information via remote access. Such donor information may include, for example, previous health history, exam results, and donation history. The donor web services module 287 further allows donors to schedule donation appointments and to complete the health history questionnaire remotely prior to applying for donation at the donor center. The donor web services module 287 also provides a FAQ section, allowing donors to assess their donation eligibility by reviewing travel maps, medication exclusions or other frequently requested information. Finally, an embodiment of the system may contain a data extraction module 278. The data extraction module 278 is used to ensure that all donor records created or modified in the database server 130 since the last successful data extraction are updated into the host database 135.

### 2. Registration Module

One embodiment of the system 10 may also include a registration module 257. The first step of the donation process may be identifying the donor at a reception workstation 100. The registration module 257 assists the staff of the donor center or the donor himself, if in kiosk mode, in performing such a first step. During identification, the staff uses the donor's unique identifier information to search for his or her profile in the system. By way of example, unique donor information may include, but is not limited to, a system-assigned unique donor ID, date of birth, social security number, driver's license number, the donor's name, etc. If the search does not find a record of the donor, the registration module 257 allows a new profile for the user to be created. The registration module 257 will provide a form to input the new donor's demographic information and generate a unique numerical identifier key (or a system assigned unique donor ID) that will distinguish each donor within the system. After the new donor's biographical information has been entered, in one embodiment, the registration module 257 takes a picture 500 of the donor for future identification.

If the donor is not new, the donor's profile is selected by the unique identifier key and retrieved from the database server 130. The registration module 257 updates the database server 130 and sets the donor's status to present. A person having ordinary skill in the art will appreciate that the embodiment of the system 10 may use other identification means to verify the donor's identity, e.g., RFID, magnetic strips, biometrics identifier such as fingerprints, etc.

If the registration module 257 finds a match at the initial search based on the donor's information, the results of the search are displayed in a search results list 400 on the workstation 100 as best seen in FIG. 4. The search results list 400 displays all of the donors who match the input criteria and indicates which donors on the list may be selected by the user. The donors are ranked to facilitate identifying the donor's actual record. Records are listed according to rank, from the most likely to the least likely match. The ranking rules are designed to aid the staff in selecting the most likely donor and identifying possible duplicate donors. The user selects the donor's profile from the search results list 400. The registration module 257 uses the donor's unique identifier key to retrieve the donor's profile from the database server 130. The selected profile is then displayed to the user as shown in FIG. 5. The display 241 shows the donor picture 500, biographical data 520, donor deferrals 540, attributes 560, and donation history 580. In one embodiment of the invention, the staff uses the donor picture 500 to verify the donor's identity. If the identity of the donor is correct, the registration module 257 begins the donor's session. If the donor's identity is incorrect, the staff can select another profile from the search results list 400, or can create a new profile as previously described.

Subsequently, the donor is subjected to an automatic pre-screening to determine his or her initial eligibility. During the pre-screening, the registration module 257 reads the donor deferrals 540 and calculates the donor's eligibility based on previous deferrals and donations, accumulative red cell, plasma or platelet loss over the past 12 months, as well as the current donation information. In an embodiment of the system, the registration module 257 may optionally connect to an external data source to screen the donor during the registration process. If the donor is deferred, for example, because the donor made a donation the day before, the registration module 257 halts the donation process. A deferral can come at any time during the donation process.

A person having ordinary skill in the art will appreciate that a deferral is a term of art which indicates that the donor is precluded from donating either temporarily or permanently. When a donor is deferred, each software module 250 disclosed for the system 10 takes specific steps as required by industry regulations. First, the donor's attempt to donate may be inserted into the database server 130. Second, the software module 250 uses printer 243 to print a letter explaining why the donor is not eligible for the donation. The letter may also contain a system-calculated date on which the donor will be eligible for donations.

### 3. Interview Module

One embodiment of the system may contain an interview module 251. In the interview module 251 (FIG. 2), the user of the workstation 100 is the donor. If the interview module 251 does not have a local cached copy of the readable medium 220, the interview module 251 connects to the database server 130 to obtain the most recent version. Once cached, the interview module 251 stores the copy of the readable medium 220 in memory 280. The interview module 251 then reads and interprets the instructions contained within the readable medium 220 to create a sequence of questions in memory 280 which have attributes, options and ranges. A discussion of the questions' attributes, options and ranges is provided later in the specification.

As best seen in FIG. 3, the user enters unique identifier information into the workstation 100 by way of the keypad 300 and selects OK 350 choice of the input module 210. At this point, the interview module 251 updates the interview status 1510 of the donor (FIG. 15B) in the database server 130 to indicate that the user is at the direct interview stage. The interview module 251 then asks the user questions visually through the display 241 and/or by using the audio device 242. The user answers the questions by using the input module 210. The interview module 251 responds to the user's answer by following the instructions for processing the information within the readable medium 220. This process continues until all questions have been answered or the questioning is halted by the interview module 251 or by the staff.

As best seen in FIG. 6, the interview module 251 visually presents questions as question text 610 on the display 241. The user responds to the questions by selecting any of the buttons in a question response area 650 of the display 241. Question responses may include multiple choice responses, such as a yes 630 function and a no 620 function, or navigational responses such as a back 660 function and a next 670 function. In one embodiment, the interview module 251 disables the question response area 650 of the display 241 until the question has also been presented via the audio device 242 of the workstation 100. As best seen in FIG. 7, the interview module 251 supports multiple languages and allows the entire interview, including the audio, to be presented in the donor's preferred language.

An embodiment of the system may include additional responses such as a replay 680 function, and a not sure 640 function. The replay 680 function audibly replays the question for the user again on the audio device 242. If the user does not know the answer to a question, the system provides a not sure 640 function. In this case, the question may be presented in an alternative form, if available. Additionally, the interview module 251 checks to see if the user is allowed to skip the question as defined by the readable medium 220 and if so, the question may remain unanswered when the donor engages the not sure 640 function. If the donor skips the question, the system provides an alternative form of the question, if available, and continues to wait for the users input.

The interview module 251 allows the donor to edit or review answers using the navigation functions. A next 670 function and the back 660 function, allow the user to go forward and backward respectively based on the donor's progress within the interview. However, not all answers can be edited by the user and some can only be viewed on the display 241. A person having ordinary skill in the art will appreciate that certain responses may be disabled to prevent the user from engaging an improper response. For instance, as seen in FIG. 8, an embodiment of the system prevents a user of the interview module 251 from skipping questions that needs to be answered.

Similarly, the interview module 251 will disable the back 660 function if the donor is at the first question presented. If the user is allowed to press the next 670 function or the back 660 function and the user engages either response, the registration module 257 displays the proper question. If the question has already been answered, the user's response will be highlighted and the user may choose to edit his or her response in the question response area 650. If the user is not permitted to edit the response, the question response area 650 will be disabled.

Before proceeding to the next question, the interview module 251 checks to see if the answer is defined as an exceptional response. An exceptional response is an answer that may have negative implications and may require additional information. If the answer is not exceptional, the interview module 251 continues to the next question. However, if the answer is exceptional, the interview module checks to see if there are any reflexive questions to insert into the question sequence. As best seen in FIG. 8, reflexive questions are displayed in the sub-question text area 800. The user then responds by selecting any of the responses in the question response area 650. Additionally, the interview module 251 may optionally interrupt the interview. Staff intervention may be required to re-establish donor eligibility in the event of an interruption. If there is no interruption, the user proceeds to the next question.

To facilitate donor facility operations, the interview module 251 also includes the ability to conduct surveys. Survey questions, as best seen in FIG. 9A, provide feedback to the donor facility in order to improve the quality of service. The donor responds to the survey questions by selecting from one or more multiple choice answers 900. The interview module 251 may store survey information in the database server 130. A person having ordinary skill in the art will understand that any of the software modules 250 may insert the donor's responses into the database server 130 at any time during or after the interview process whether by individual response, a group of responses, or all responses simultaneously.

### 4. Automated Kiosk Module

An embodiment of the system may optionally contain the automated kiosk module 260, which contains a self-authenticating mechanism operating on the workstation 100. It minimizes the need for staff involvement in the registration process. The user of the automated kiosk module 260 is the donor. The self-authenticating mechanism uses the donor's unique identifier key or another means to obtain the donor's unique identifier key. The workstation 100 loaded with the automated kiosk module 260 may use input devices such as a magnetic card reader 215, a bar code scanner 216, a biometrics reader 219, etc., to identify and validate a user. One of skill in the art will appreciate that any number of validating alternatives may be used. The automated kiosk module 260 uses the data from the authenticating mechanism to connect to the database server 130 and retrieve the donor's profile. At this point, if needed, the donor can cancel the self-authenticating process and return to the self-authentication screen to reattempt registration. If the automated kiosk module 260 does not have a local cached copy of the readable medium 220, the automated kiosk module 260 connects to the database server 130 to obtain the most recent version. Once cached, the automated kiosk module 260 stores the readable medium 220 in the memory 280. The automated kiosk module 260 then reads and interprets the instructions contained within the readable medium 220 to create a sequence of questions in the memory 280 which have attributes, options, and ranges. Attributes, options and ranges are discussed in a later part of the specification.

Once the donor is authenticated, the automated kiosk module 260 performs similar functions as the registration module 257 and the interview module 251. The automated kiosk module 260 sets the overall status 1500 (FIG. 15B) of the donor to present in the database server 130, screens the donor for any deferrals 540, and then sets the interview status 1510 of the donor in the database server 130 to direct. The automated kiosk module 260 then performs the interview process as using the interview module 251. When finished with the interview, the automated kiosk module 260 waits for the next donor.

### 5. Review Module

An embodiment of the system may also include a review module 252. The users of the review module 252 are the staff of the donor facility who may review the donor's answers and ask further questions. If the review module 252 does not have a local cached copy of the readable medium 220, the review module 252 must connect to the database server 130 to obtain the most recent version. Once obtained, the review module 252 stores the copy of the readable medium 220 in the memory 280. The review module 252 then reads and interprets the instructions contained within the readable medium 220 to create a sequence of questions in memory 280, wherein the questions may have attributes, options, and ranges. The review module 252 also includes the ability to calculate a donor's eligibility based on the responses.

The review module 252 displays a list of donors on the reception screen and identifies which donor should be selected next. The staff selects the next donor and verifies his or her identity by using the donor picture 500, or any other means. Once the donor's identity is verified, the review module 252 connects to the database server 130 and updates the donor's overall status 1500 (FIG. 15B) to present. The review module 252 presents additional questions for the staff to ask the donor in light of answers provided to the interview module 251. The question sequence may contain new questions or additional reflexive questions that can only be asked by the staff. Finally, the question sequence may contain questions that the donor did not understand and was able to skip at the interview module 251. In addition, as best seen in FIG. 10, the review module 252 allows the staff member to edit the donor's responses and requires the staff member to make comments on any changes. The review module 252 provides a staff review notes field for the purpose of entering any required, or additional comments.

The review module 252 disqualifies donors based on an exceptional (non-nominal) answer and creates a deferral in the database server 130. When a disqualifying response is provided, the review module 252 determines what type of deferral is created. A deferral may be temporary or permanent. A temporary deferral may be a certain number of hours, days, or years. At the expiration of the temporary deferral period, the donor will be permitted to donate again. The deferral is inserted into the donor deferrals 540 section of the donor's profile in the database server 130.

When the review is completed, the review module 252 requires the donor to read and sign a consent form as shown in FIG. 11. The consent form text 1100 is displayed and requires the donor to consent to the donation and acknowledge his or her truthful responses by signing his or her name. The donor uses the digitizing pad 217 to sign his or her name on the pad by using a stylus. The digitizing pad 217 captures the motion of the stylus as a digital representation of the donor's signature. The signature is then presented on the display 241 and stored in the database server 130. The donor has the option of consenting by selecting the OK 350 function to advance to the next process or field or selecting the clear 1175 function to clear the signature 1125 field, thereby not advancing. A person having ordinary skill in the art will appreciate that the touchscreen 214 or any equivalent digitizing method may be used to capture the donor's signature. When a donor's review is completed, the review module 252 connects to the database server 130 and updates the interview status 1510 of the donor to complete. The staff is then presented with the queue and the review of the next donor begins.

In an alternate embodiment of the invention, the system may be used in conjunction with the devices in question to capture the signature using the digitizing pad 217 and a modified version of the display 241 and/or touchscreen 214.

In an alternate embodiment of the invention, the system may include signature recognition, for example, the system could compare the signature with a historical record of that signature for authenticity.

### 6. Vitals Module

One embodiment of the system may contain a vitals module 253. The users of the vitals module 253 are blood center staff. The donor is given a physical exam at the vitals module 253 after completion of either the registration module 257 or the review module 252. Furthermore, a person having ordinary skill in the art will appreciate that the vitals module 253 may be incorporated into any of the other modules. The vitals module 253 displays a list of donors and identifies which donor should be selected next. The staff selects the next donor and verifies his or her identity by using the donor picture 500, or any other means.

At this stage, a staff member takes measurements of the donor and enters them into the vitals module 253. As best seen in FIG. 12, this data may optionally include a height 1200 field, a weight 1205 field, a body temperature 1210 field, a blood pressure 1220 field, a pulse 1230 field, a regular pulse 1240 field, a arms okay 1250 field, a hemoglobin 1260 field, a hematocrit 1270 field, etc. An embodiment of the system creates three different ranges for measurements, nominal, impossible and exceptional. Nominal measurements or measurements within a nominal range, are defined as good measurements within the readable medium 220. Impossible measurements are measurements that cannot be possible and must be a result of human error. Finally, exceptional measurements are measurements that may have negative implications and require additional information. A person having ordinary skill in the art will appreciate that the impossible range, and either the nominal or exceptional range, needs to be defined within the readable medium 220. Each range may consist of a list of values, a single value, a numerical range, or a single numerical value.

First, the measurement provided by a user is compared to the impossible range as defined within the readable medium 220. If the measurement is within the impossible range, the measurement is rejected. Otherwise, the measurement is stored in the database server 130 and then the measurement is compared with the nominal range defined within the readable medium 220. If the measurement is within the nominal range, the answer is accepted and the user proceeds to the next measurable parameter. If the donor's measurement is not within the nominal range and not within the impossible range, it may therefore be within the exceptional range. On the occurrence of an exceptional measurement, the vitals module 253 interprets and executes any step as defined by the readable medium 220.

The staff of the donor center may be presented with potential deferrals based on measurements of the potential donor. If the measurement is outside of the nominal range as defined by the readable medium 220, the donor may be deferred. The vitals module 253 also checks to see if the measurement is within an impossible range as defined by the readable medium 220. If so, the vitals module 253 prevents the staff member from entering the measurement, and the measurement may have to be re-taken.

The vitals module 253 also permits the staff to make a second measurement in the event of an exceptional measurement. As best seen in FIG. 13, the staff may make a second measurement in one or more alternate measurement 1300 fields. Additionally, the staff may make notes regarding the physical exam in the measurement notes 1280 field. As best seen in FIG. 13, the staff member may manually remove a deferral and pass the donor to allow the donation once the vitals measurement is complete. When the measurements of the current donor are completed, the vitals module 253 sets the exam status 1520 of the donor in the exam stage to either failed or passed. The staff is then again presented with the list of donors and can begin measuring the next donor.

### 7. Donations Module

An embodiment of the system also includes a donation module 254. The users of the donation module 254 are staff of the donor facility. The donation module 254 contains a queue which displays a list of donors and identifies which donor should be selected next. The staff selects the next donor and verifies his or her identity by using the donor picture 500, or any other means.

As best seen in FIG. 14, before the donation can begin, a start 1400 function, a save 1410 function, a success 1415 function, and a retry 1425 function are disabled. To enable the functions and begin the donation, the staff may have to first enter or scan in a donation unit number 1470 of the blood bag. Once the blood bag is registered with the system, the start 1400 function, the save 1410 function, the success 1415 function, and the retry 1425 function are enabled, as best seen in FIG. 15A. The user begins the donation process by pressing the start 1400 function, which automatically sets the start time 1430 field. When the donation is complete, the stop time 1445 field is set by selecting the stop 1405 function. During or after the donation, the staff may enter information into a RBC loss 1435 field, a plasma volume loss 1450 field, an arm 1455 field, a reaction 1460 field, a draw codes 1465 field, or make notes in a donation annotations 1475 field. At this point, the donor is finished with the donation and may exit the donation center. The donation module 254 then returns to display the list of donors and the next donor is selected.

A person having ordinary skill in the art will understand that optional hardware modules may be included in the embodiments of the system to further automate the donation module 254. One such hardware module may draw blood, weigh the blood bag and send data to the donation module 254 for processing. Another may be the use of a hand-held device for easy portable entry of the donation information. In another embodiment of the system, an electronic scale/mixing device may facilitate entry of donor/donation information, which can then be uploaded into the database server 130. The donation module 254 may use the information provided by the optional hardware modules to set the start time 1430 field when beginning to draw blood and to set the stop time 1445 field to stop once a certain mass has been obtained. In such embodiments, a person having ordinary skill in the art will accordingly understand that certain features of the module may be disabled.

### 8. Lot Release Module

An embodiment of the system may also include a lot release module 259. The lot release module 259 is a type of review module used by supervisory staff to ensure that each donation has sufficient documentation necessary to release the donation as required by industry regulations. The lot release module 259 accordingly allows the staff to review donation and deferral records generated by the system 10 in an efficient and accurate manner.

The lot release module 259 performs automatic screening of donors and may automatically release donors who have sufficient documentation in the record. A list of documents for review is generated by the lot release module 259 when the donor's record does not meet the minimum documentation requirement. This list may also include donors that were deferred from the donation. As best seen in FIG. 15C, the staff is presented with the first donor's record. The staff determines if the record is sufficient enough to allow the release of the blood donation. Release status is set by choosing from a release not ok 1550 option or a release ok 1540 option. This action must be approved by the supervisor. The staff may set the release status by engaging a release and print record 1560 function or a release donation 1565 function. The staff may elect to use a skip 1570 function if they do not want to set the lot release status.

In the event members of the staff are examining a deferral, they determine whether sufficient documentation is present to warrant the deferral. The members of the staff proceed through the same steps described above to approve the deferral, disapprove the deferral, or skip the deferral. Once the record has been viewed, and the lot release status has been set to release not OK 1550, release OK 1540 or skipped, the next record in the list is presented. This process continues until there are no more records that can be reviewed.

### 9. Management Module

An embodiment of the system includes a management module 256 to facilitate the management of the donation center operations. The users of the management module 256 are blood center staff. A list of donors is displayed in the waiting room sub-window of the reception screen, which displays all donors' current status within the system. As best seen in FIG. 15B, the management module 256 is divided into stages of the donation process and the donor's current status. Also displayed is a donation procedure 1515 that the donor is interested in and a donor wait time 1505, which is the total time the donor has waited in minutes to give a donation. In another embodiment of the system, the waiting room sub-window depicts a visual representation of every donor room station with the donor wait time 1505, the donation procedure 1515 and identity of the donor(s) at that station. This allows a user to undertake operation oversight using a more user-friendly, graphical presentation.

There are multiple statuses that the donor may be assigned during the donation process, as seen in FIGS. 15E and 15F, where FIG. 15F provides further explanation of the possible statuses listed in FIG. 15E. As seen in FIG. 15B, the management module 256 may display an overall status 1500, an interview status 1510, and an exam status 1520. It would be obvious to a person having ordinary skill in the art that any number of status displays may be combined into a single list or expanded to include more detail.

As best seen in FIGS. 15E and 15F, within the overall status 1500 (FIG. 15B), the donor may be assigned a status related to the entire donation process. For example, as best seen in FIG. 15, the user may set the donor's status to “present” while processing through the screening. When the interview and review are completed, the donor's status may be set to “interviewed.” The donor's status may similarly be set to “ready,” when he or she has completed the screening and is waiting to donate. Once the donation is complete, the donor's status may be set to “complete.”

Moreover, a donor may be given a different status if the donation does not occur. A “rejected” status may be assigned to the donor if he or she is found to be ineligible during the registration. Further, a donor may leave at any time during the donation screening process and accordingly would be assigned a “bailed” status. “Bailed” can be a temporary status, however, as it is possible for the donor to return and resume the donation process within a configurable amount of time with permission of staff with a special capability. Finally, the donor may fail the screening process for any number of reasons. If the donor fails at any stage of the donation, he or she may be assigned the “failed” status.

As seen in FIG. 15F, the donor's status may also be blank, indicating that a user has not yet interacted with the module. The donor's status field may also be set to “passed” to indicate successful completion of the module. In addition, as shown in FIG. 15F, the donor's status may be set to indicate the current procedure the module is engaging in. One of skill in the art will appreciate that any number of process 1525, process progress 1530, overall status 1500, interview status 1510, and exam status 1520 records may be possible as shown in FIG. 15F, which includes a non-exhaustive sampling of work flow monitoring steps. For example, FIG. 15F shows that the monitoring step “phlebotomy successful” process progress 1530 in the “blood donation session completed” process 1525 results in the “complete” overall status 1500, the “passed” interview status 1510, and the “passed” exam status 1520.

In addition, the management module 256 may also display the donor's progress within different modules. As seen in FIG. 15B, the donor's status within the interview module 251, the review module 252 and the vitals module 253 may be displayed.

### 10. Editor Module

An embodiment of the system 10 may include an editor module 255. The users of the editor module are the blood center staff. In one embodiment, the editor module 255 allows the creation of the readable medium 220, which may be interpreted by other modules including, but not limited to, the interview module 251, the review module 252, the vitals module 253 and the donation module 254. The user of the editor module 255 is a staff member with specific function related capabilities. The editor module 255 allows the user to add, edit, and update questions that will be presented to users of any of the modules. These may change the content, appearance and decision logic associated with the questions.

In an embodiment of the system 10, the editor module 255 allows a user with the appropriate capabilities to create new donor questionnaires (forms), clone or modify existing donor questionnaires by adding or removing questions. The editor module 255 allows the user control over what questions or questionnaires are used for a specific type of donor interview. For example, the editor can apply logic that determines if a donor is eligible for an “abbreviated” questionnaire, based on configured industry regulations. The editor module 255 supports the creation of multiple types of questions. Direct questions are self-administered questions that the donor may answer at the interview module 251. Indirect questions are questions that must be administered through a screener in lieu of the donor using the self-administered, computer assisted questionnaire. Seasonal questions are displayed to the user only at user-defined (configurable) times of the year, e.g. exposure to West Nile virus. The editor module 255 also supports creation of reflexive questions, which are sub-questions that can be administered at the interview module 251 or asked by the staff during review.

Additionally, the editor module 255 supports options. Options are defined as properties of the question and represented by a true or false value. Some options include the rejectable flag, the skippable flag, the alternate form available flag, and the interruptible flag. The rejectable flag, determines if an answer may be changed once answered. The skippable flag allows the question to be skipped. The alternate form flag indicates that there is an alternate form of the question available. Finally, the interruptible flag causes the system to halt questioning if the donor provides an exceptional response. The editor module also supports ranges. Ranges are properties of an answer and are defined as the difference between the smallest and largest values that are acceptable for a specific question.

Finally, the editor module 255 supports alternate set of attributes such as language, sex, and the date of expiration. The date of expiration attribute, for example, prevents the question from being used beyond the expiration date. The sex attribute would indicate that the question is only proper for a person of a specific sex.

The deferral attribute is also created in the editor module 255. The deferral attribute is used to define deferral information in the event of an exceptional answer. The deferral attribute contains information such as whether the deferral is temporary or permanent. If the deferral is temporary, the length of the deferral is predefined in the attribute.

The highlight attribute is another example of an attribute. The embodiment of the system understands that a portion of the question may be highlighted to call attention to it. Finally, a definition attribute may optionally be included. A definition attribute underlines a word or a sequence of words in the question to indicate that a definition is available. When a donor clicks on the underlined section, a window appears with the definition.

### 11. Synchronization Manager Module

An embodiment of the system 10 may contain the synchronization manager module 270. The users of the synchronization manager module 270 are the blood center staff. It updates the database server 130 and/or one or more mobile database servers 110 with information of donors that have been processed through the system. Synchronization is the action of updating one set of data based on another similar, more up to date set of data. The one or more mobile database servers 110 may be specifically configured to run the synchronization manager module 270 and may require a connection to the database server 130 to begin the synchronization process. The synchronization manager module 270 allows the user to start and end the synchronization process; generate a conflict report; and delete conflicts. After the synchronization ends, the system will automatically display the Synchronization Conflict Report on the screen, which the user can choose to print. The conflict report lists conflicts that could occur during synchronization, such as modifications made to an existing record on more than one database server 130, modifications made on the one or more mobile database servers 110 that no longer exist on the database server 130, or a new record created on more than one database server 130 with the same ID. Any conflict must be resolved by the user outside of the synchronization manager module 270.

### 12. Workstation Manager Module

An embodiment of the system 10 may include the workstation manager module 272. The workstation manager module 272 is accessible from the Reception window menu bar. It allows blood center staff with function specific capabilities to create at least one workstation 100 for the system application. The workstation manager module 272 system documents the creation time, date, and the user ID of the person who created the workstation 100. For each workstation 100 created, the workstation manager module 272 also stores the unique ID (network name); name; associated center; and a short description. Workstation 100 functions are configurable and can be task specific, e.g., the workstation 100 must be configured to be able to run the synchronization manager module 270. The workstation 100 list can be retrieved from the workstation 100 sub-window. Details of each workstation 100 can be viewed by selecting the row for that workstation 100.

The workstation manager module 272 also provides users the capability to modify information for the workstation 100. All modifications are tracked, including the modifying user, the modification time and the information modified. A user logged into a center will only be able to view, modify and create sites for that particular center. The workstation 100 ID and its associated center cannot be modified.

### 13. Drive and Site Manager Module

An embodiment of the system 10 may also include a drive and site manager module 274. In an embodiment, the drive and site manager module 274 allows blood center staff with function specific capabilities to create and modify parameters associated with the donation process. Further, the drive and site manager module 274 allows the user to create and modify a site, as well as create, modify and select a drive for particular donor collection events. For every donor registration and donation activity performed with the system, there may be a site and a drive configured.

The site created by the drive and site manager module 274 is the physical location where donation activities occur. The site is associated with the center that the user is logged into, and as previously stated a user logged into a particular center will be able to view, modify and create sites for that center only. A workstation 100 can be configured to be associated with one site, which means that the workstation 100 will assume the configured site and the current date as a ‘drive’ for that workstation 100. The drive and site manager module 274 is used to create a new site or edit the details of an existing site. Site modifications are tracked by the system 10 or by the workstation 100, including the modifying user, the modification time and the information modified.

Additionally, the drive and site manager module 274 may optionally create drives. A drive is one donation event at a particular site, and is comprised of a site name and a date. The drive is associated through its site to a particular center. When a workstation 100 is configured for a site, that workstation 100 will automatically assume the drive associated with the configured site. When a workstation 100 is not configured with multiple site(s), the user can select a drive for sites associated with the center that the user logs into. The drive and site manager module 274 may optionally view the details of an existing drive or edit those details. The Drive List sub-window is populated with all active drives for the center the user is logged into. Last, all drive modifications are tracked by the system 10 or by the workstation 100, including the modifying user, the modification time and the information modified.

### 14. User Administration Module

An embodiment of the system contains a user administration module 276. The user administration module 276 is used by the blood center staff to maintain up-to-date information about authorized users. This includes but is not limited to a system user's ability to create new users, modify information or capabilities for current users, deactivate currently active users, reactivate currently inactive users, change passwords for users, create user groups and assign users to user groups. The user administration module 276 also possesses the capability to unlock workstations 100 that, for instance, have been locked due to a suspected hacking attempt on the system. The user administration module 276 is accessible from the reception window. It is divided into five main sub-windows. As can be seen in FIG. 15D, the users-groups sub-window 1575 displays a single selection list of all users or groups on the system; the users-groups sub-window 1575 contains fields for creating and modifying users or groups; the group membership sub-window 1580 displays the capabilities available for the selected user or group; the centers sub-window 1585 displays available center locations; the capabilities sub-window 1590 displays a selection list of all capabilities on the system, including the capability ID and description.

### 15. Data Extraction Module

An embodiment of the system includes a data extraction module 278. The data extraction module 278 is used by the blood center staff to ensure that any donor records that have been created or modified in the database server 130 since the last successful data extraction are updated into the host database 135. The host database 135 is the main information holding database. The data extraction process can be scheduled to run automatically. The process is incremental in that it does not extract all records from the database server 130; only new or modified records are extracted. A directory is created for each extraction process where all the files generated by the extraction process are stored. The donor information is extracted based on the creation date, from the table containing the donor's data, and the modification date, from the table containing the before images of changes to the donor's data. A new donor record sent from the database server 130 to the host database 135 includes a unique system identification number, which is necessary for the system to re-identify the new donor in the future. The information extracted from the system is configurable based on the information needed by the host database 135. Certain information that is available to be extracted from the system may not be compatible with all host databases 135. Regardless, the additional information is maintained in the database server 130. If any errors occur during the extraction process, the error is logged and the extraction is stopped. The system automatically sends an email notification to a configured user that the error occurred.

Information for a donation is extracted from the system only if the donation has been approved by the lot release module 259. A configurable list of fields from the donor record is extracted, e.g., donor ID, system ID, donor name and demographic information, creation/modification information, etc. A configurable list of fields from the donation record is extracted, e.g., draw date, donation ID, site and donor ID, plasma/red cell loss, lot release date/time, etc. A configurable list of fields extracted from the deferral and attribute records, e.g., the deferral or attribute code, the start and end time of the deferral or attribute, the time the deferral or attribute was recorded, etc. A configurable list of fields for vitals information is extracted from the system, e.g., the number values from the vitals record (height, weight, blood pressure, etc.); qualitative information such as pulse regularity and arm check; donation ID; etc.

### 16. Donor Manager Module

An embodiment of the system may contain a donor manager module 279. The donor manager module 279 allows the blood center staff to manage and view donors records. To make changes to the donor's record, the user must possess the donor manager capability provided by the user administration module 276. A person having ordinary skill in the art appreciates that an additional capability may be required to make changes to information about the donor that is used as donor search criteria.

There are three primary functions of the donor manager module 279. First, the donor manager module 279 allows the user to modify a donor's record; apply and rescind deferrals and attributes; analyze and resolve or merge duplicate donor records; print a blood donation record; and perform ad hoc eligibility checks of a donor. Additionally, the user of the donor manager module 279 may search the system to find donors who match the entered last name and date of birth, or a unique identifier key. Finally, the donor management module 279 assists in finding and quarantining blood units from prior donations when a repeat donor becomes positive for certain infectious disease assays.

### 17. Medical Module

One embodiment of the system may contain a medical module 281. The medical module 281 is used primarily by medical professionals for documenting the physical examination or the health history, such as would occur in a medical professional's office, or if for a blood donor, recording a more extensive examination than that normally performed prior to routine blood donation. In all cases, the medical module 281 presents the user with additional specific interview questions; a form for recording physical findings and the care providers' notes; and electronic signature functionality that utilizes the digitizing pad 217.

### 18. Resource Management Module

One embodiment of the system may contain a resource management module 282. The users of the resource management module 282 are the staff of the donor facility. The resource management module 282 assists the staff with three routine administrative tasks: inventory and equipment management, staff scheduling, and donor collection scheduling. The module computes the number of donors required each day to meet center-set revenue goals and hospital customer needs; it takes into account historical seasonal usage and outdate rates. After establishing the draw numbers, the resource management module 282 will calculate the amount of equipment needed, subtract it from a pre-entered inventory, and alert the user if inadequate supplies or equipment exists. Likewise, the system calculates the number and type of staff required at each collection site and schedules them accordingly; the system has configurable rules that prevents scheduling mistakes, known in the art to occur when, for example, a staff user schedules too many hours in one day or not enough time off between scheduled days.

### 19. Sample Management Module

One embodiment of the system may contain a sample management module 283. The users of the sample management module 283 are the staff of the donor facility. The sample management module 283 assists the staff with tracking and managing the donor pilot tubes obtained with every blood donation. By reading the bar-coded labels on the tubes, the sample management module 283 determines what type of anticoagulant is contained in each tube, associates each tube with its donor, and alerts the staff if inadequate or incorrect samples have been obtained.

### 20. Customer Relations Module

One embodiment of the system may contain a customer relations module 284. The users of the customer relations management module 284 are the staff of the donor facility. The customer relations module 284 assists the staff with three routine administrative tasks: donor identification cards, donor recognition and donation credits.

### 21. Donation Correlation Management Module

One embodiment of the system may contain a donation correlation management module 285. The users of the donation correlation management module 285 are the staff of the donor facility. The donation correlation management module 285 manages all correlated donations, i.e. directed and autologous donations. The donation correlation management module 285 provides case management by documenting all information related to the donor (diagnosis, medical professional, hospital, number and type of products ordered, procured and distributed, etc.) and the information regarding the blood donor(s) (name, product, blood donation number, release form with electronic signature, etc.). At a configurable time prior to need, the system generates warning messages when pending order requests are unfilled. The system generates reminder messages for blood center staff to ensure that the products are distributed correctly. The system generates promotion materials for individuals that have the potential to be regular donors.

### 22. Manual Recovery Module

One embodiment of the system may contain a manual recovery module 286. The users of the manual recovery management module 286 are the staff of the donor facility. The manual recovery module 286 provides a backup method for the batch entry of paper forms that are generated when the system is down, e.g. during a major hardware malfunction. The system allows the user, when in the manual entry mode, to enter the registration, screening and donation information from backup paper records. The manual recovery module 286 is configurable to allow all or part of the information to be entered. For example, only donor name, donation number and product can be manually keyed into the system, or, in an additional embodiment, the system is capable of electronically scanning the documents to accommodate the full future retrieval of all data.

### 23. Donor Web Services Module

One embodiment of the system may contain a donor web services module 287. The users of the donor web services module 287 are the blood donors. The donor web services module 287 provides convenient remote web access for the donor to access his or her previous health history exam results and donation history. The donor web services module 287 can assess current donation eligibility via an online health history interview, allowing the health history questionnaire to be completed prior to traveling to the blood center, thus saving the donor's valuable time. The system can be used for the donor to schedule a donation time and location, providing the most convenient site(s) for a specific requested date.

### II. Embodiment of the Invention

### A. In General

For illustrative purposes only, an embodiment involving a plurality of workstations 100 and kiosks used to create a logical progression in the donor screening process will be described herein. An overview of this embodiment is best represented by the logical flow charts shown in FIGS. 16A and 16B. FIG. 17 illustrates how a plurality of workstations 100 may be dedicated for specialized functions such as registration, interviewing, etc. [As best seen in FIG. 17, an embodiment of the system consists of at least one registration workstation 1705, at least one interview workstation 1700, at least one review workstation 1720, at least one vitals workstation 1740, at least one donation workstation 1780, and at least one management workstation 1760.] In this embodiment, the donor travels between the dedicated workstations for the collection of data, a physical examination, and then finally the blood donation. Management oversight of the donor room operations may occur at any of the dedicated workstations. A person having ordinary skill in the art will appreciate that this is but one embodiment and any number of configurations may be used, such as combining all functions into a single workstation 100.

A donor registers at either the registration workstation 1705 or a self registration workstation 1710. Either dedicated workstation begins by locating the donor's profile. If the donor profile eliminates him or her, the donor is deferred from making a donation. If not, the donor proceeds to the interview workstation 1700. The interview workstation 1700 asks the donor questions and the donor responds by using a keyboard and mouse 212 or the touchscreen 214. Here, if the donor provides an answer that eliminates him or her, the donor can be deferred from making a donation. The donor proceeds to the review workstation 1720 after all the interview questions have been addressed.

At the review workstation 1720, the donor center staff asks the donor additional follow up questions. The donor center staff inserts the donor's responses into the review workstation 1720 by using the keyboard and mouse 212 or the touchscreen 214. If the donor provides an answer that eliminates him or her, the donor is deferred from making a donation unless the donor center staff elects to manually pass (override) the donor. If the donor passes, or is manually passed, he or she proceeds to the vitals workstation 1740 where he or she is given a physical exam. The donor center staff collects measurements from the donor and inserts the data into the vitals workstation 1740. In the event a measurement falls outside a nominal range, the donor could be deferred from making the donation. If the donor passes, the donor is then permitted to move to the donation workstation 1780 to make a donation.

### B. Registration Workstation

A donor begins by registering at the registration workstation 1705 or self registering at the self registration workstation 1710. The registration workstation 1705 consists of at least one workstation 100 executing the registration module 257. Likewise, the self registration workstation 1710 consists of a workstation 100 executing the automated kiosk module 260. If the donor is a new donor, then the donor must be registered by the donor center staff with the registration workstation 1705.

First, the staff asks for and enters unique identifier key information into the registration workstation 1705 to search for a previously created donor profile, as best seen in FIG. 3. Input is confirmed using the OK 350 function. The registration workstation 1705 searches the database server 130 for a donor who has the same unique identifier key. A list of matches is displayed as shown in FIG. 4. The staff selects and views the appropriate profile as best seen in FIG. 5. In one embodiment, using the donor picture 500, the staff verifies the identity of the donor and then selects the donor's profile. Next, the donor undergoes the prescreening process or registration. During the screening, the registration workstation 1705 reads the donor deferrals 540 and calculates the donor's eligibility based on previous donations, previous accumulative blood, platelet and plasma loss, previous deferrals and the current date. If the donor is deferred, for example because the donor made a donation the day before, the registration module 257 halts the donation process and changes the donor's status to “rejected.” Or, if the donor has cumulatively lost more than a predetermined amount of red cells over the past 12 months, the system may determine him to be ineligible to undergo certain donation procedures, even though he has met the criteria for not donating too often or too many times. If the donor is not deferred, his or her session ends with the registration workstation 1705 and the donor moves to the interview workstation 1700.

If the donor is not found in the database server 130, the registration workstation 1705 provides a new donor form. The staff asks the donor for his or her biographical as well as other relevant information and enters the information into the form. When complete, the staff uses the digital camera 211 to take the donor picture 500. The data, including the donor picture 500, are inserted into the database server 130 and a unique identifier key is generated for the donor. Optionally, the registration module 257 may create a physical object which can later be used to identify the donor. Such an object may include, for example, a magnetic card or a card with a barcode, either of which identify the donor based on his or her unique identifier key. The new donor then proceeds to the pre-screening process of the registration, as described above for the pre-existing donor.

If the donor is a repeat donor, the donor may elect to use the self registration workstation 1710 to register with the system. If the donor decides not to, or does not have the necessary materials to register, he or she may use the registration workstation 1705 to register with the assistance of the staff as described above. If the donor elects to self register, the donor uses unique identifier information generated on a magnetic card or a card with a barcode to register with the system. The system reads the information on the card by using the magnetic card reader 215 or the bar code scanner 216 attached to the self registration workstation 1710. The system searches the database server 130 for a donor who has the same unique identifier information and retrieves the donor's profile.

Before the prescreening process begins, the workstation 100 displays the donor's profile, as seen best in FIG. 5. The donor's profile contains information such as the donor's biographical data 520 and the donor picture 500. The biographical data 520 and the donor picture 500 are always displayed on the display 241 when the donor is being processed at any of the workstations 100 in the system. The donor's profile also shows any donor deferrals 540, attributes 560, and donation history 580. The donor then proceeds through the pre-screening process as described in the registration workstation section above. If the donor is not deferred by the prescreening process, the donor then begins the self-administered interview process described below.

### C. Interview Workstation

The interview workstation 1700 is best represented by the logical flow chart as depicted in FIG. 18. At this stage of the donation process, the user of the system is the donor, and the interview workstation 1700 consists of at least one workstation 100 executing the interview module 251. The interview workstation 1700 begins by updating the interview status 1510 of the donor in the management workstation 1760 to direct and save it in the database server 130. Before starting the interview, the donor may select his or her preferred language. All interaction between the donor and the interview workstation 1700 from this point forward will be in donor's preferred language.

The interview workstation 1700 begins the process by accessing the readable medium 220. The readable medium 220 instructs the interview workstation 1700 to visibly display questions to the donor on the display 241. The readable medium 220 may optionally instruct the interview workstation 1700 to present the question using the audio device 242 of the workstation 100. Answers to the questions are displayed in the question response area 650. Answers include responses such as the yes 630 function or the no 620 function.

In the event that the donor is not eligible, a letter can be printed to the printer 243 at the review workstation 1720 indicating the reason and the day when the donor will be eligible to donate blood again. The logical flow of the interview process is best seen in FIG. 18. When the readable medium 220 instructs the interview module 251 to present questions to the current user, the interview module 251 determines first if there are any more questions. If not, the decision tree ends and proceeds to the next step of the interview module 251. If there are further questions, the interview module 251 reads the question from the readable medium 220 and displays it on the display 241 and also audibly plays the question via the audio device 242. The interview module 251 then waits for the user to input his or her answer by using any of the input methods provided by the workstation 100.

The interview module 251 first checks to see if the user has selected the replay 680 function. If so, the question is replayed on the audio device 242. If the user selects the not sure 640 function, the interview module 251 first checks to see if there is an alternative form of the question available. If so, the alternate form is displayed on the display 241 and the module waits for the user input. If not, the interview module 251 checks to see if the question can be skipped, and if so, the interview module 251 loads the next question, displays it, and waits for the user's input. If the question cannot be skipped, the interview module 251 continues to wait for the user's response.

If the user selects the back 660 function, the interview module 251 checks to see if the user is at the first question. If so, the response is not accepted and the interview module 251 awaits for the user's input. If not, the interview module 251 reads the previous question, displays the question on the display 241, and waits for the user's next input. If the user selects the next 670 function, the interview module 251 checks to see if the current question was either previously answered or if not, whether the question can be skipped. If it has been answered or can be skipped, the interview module 251 loads the next question, displays it, and waits for the user's input. Otherwise, the response is not accepted and continues to wait for the user's response.

If the user has not selected a valid response in the interview module 251, such as the yes 630 function or the no 620 function, the interview module 251 continues to wait for the user's input. If there is a valid response, the interview module 251 determines the validity of the response.

First, the interview module 251 stores the response in the database server 130 and then checks to see if the response is within the nominal range. If the answer is within the nominal range, the interview module 251 proceeds to the next question. If not, the answer must be exceptional, in which case the interview module 251 checks to see if there are reflexive questions to ask based on the original question. If there are no reflexive questions, or all the reflexive questions have been answered, the interview module 251 checks to see if the responses justify interrupting the interview.

If so, the questioning is halted and staff intervention is required. Otherwise, the interview module 251 proceeds to the next interview question, if there is one available.

The interview workstation 1700 continues until it exhausts all questions defined in the readable medium 220. When there are no more questions, the interview is finished. Once the donor's session with the interview workstation 1700 ends, the donor moves to wait in the queue for the review workstation 1720. A person having ordinary skill in the art will appreciate multiple queues may be used to differentiate donors based on language preference, physical disabilities, or any other criteria.

### D. Review Workstation

When selected by the donor center staff, the donor moves to the location of the review workstation 1720. In this stage of the donation process, the staff of the donor facility are now the users of the system. By way of overview, the logical progression of the review workstation 1720 is best represented by FIG. 19. The review workstation 1720 consists of at least one workstation 100 executing the review module 252. The donor center staff starts the donor's session by selecting the next donor from the queue displayed on the reception screen of the review workstation 1720. Next, the staff identifies the donor using the donor picture 500. Once the session starts, the review workstation 1720 connects to the database server 130, updates the donor's review module status to “present,” and retrieves the donor's answer from the interview. The review workstation 1720 then begins the review process.

The review workstation 1720 then accesses the readable medium 220 and asks questions based on the answers in the interview. The readable medium 220 instructs the review workstation 1720 to present questions to the display 241. The logical flow of the questions and the system's handling of responses follows the logical flow chart shown in FIG. 18. The questions presented may be either new questions or questions that were previously asked during the interview. If it is a question presented during the interview, the previous answer is highlighted, as best seen in FIG. 10, and the donor center staff can modify or annotate the question. The donor center staff may choose to ask further questions and record the answer in the staff review notes field. If a new question is presented by the review workstation 1720, the donor center staff audibly or visibly presents the question to the donor. The donor then replies to the question and the staff engages the appropriate response.

The review proceeds until all questions are satisfactorily answered. To continue, the review workstation 1720 requires that the donor consent to the donation by signing his or her name. For this purpose, the review workstation 1720 displays a consent form as shown in FIG. 11. The donor then signs his or her name using the digitizing pad 217 to authorize the blood donation. The review workstation 1720 uploads the digitized signature and updates the donor's status in the database server 130. At this time, the interview status 1510 of the donor is changed to “passed.” Next, the user is placed in a queue to wait for the vitals workstation 1740.

### E. Vitals Workstation

When selected by the donor center staff, the donor moves to the location of the vitals workstation 1740. By way of overview, the logical progression of the vitals workstation 1740 is best represented by FIG. 20. The vitals workstation 1740 consists of at least one workstation 100 executing the vitals module 253. In this stage of the donation process, a staff member is the user of the system. The staff starts the donor's session at the vitals workstation 1740 by selecting the donor from the queue. In one embodiment, the staff identifies the donor using the donor picture 500. When the session starts, the vitals workstation 1740 connects to the database server 130 and updates the exam status 1520 of the donor. The vitals workstation 1740 displays a form, as shown in FIG. 12, and disables the pass 1285 function and the fail 1290 function.

During the vitals measurement, the donor center staff gives the donor a physical exam and enters the results into a form presented by the vitals workstation 1740, as seen in FIG. 12. In this embodiment, the measurements are recorded in the height 1200 field, the weight 1205 field, the body temperature 1210 field, the blood pressure 1220 field, and the pulse 1230 field. The donor center staff also takes the donor's pulse and physically inspects the donor's arms of to ensure the safety of the draw. These results are recorded in the regular pulse 1240 field, the arms okay 1250 field, the hemoglobin 1260 field, and the hematocrit 1270 field. The donor center staff may also write any notes and comments in the measurement notes 1280 field.

Once a measurement is entered into any one of the fields, the vitals workstation 1740 uses the decision tree disclosed in FIG. 9B to determine the proper response. First, the module determines if the response is within the impossibility range as defined in the readable medium 220. A person having ordinary skill in the art will appreciate that an impossible range may not necessarily be defined. If the response falls within the impossibility range, the answer is not accepted and the module continues to wait for the user's response. Answers outside the impossible range are stored in the database server 130, as seen in FIG. 9B. If the answer is nominal, the vitals workstation 1740 also checks to see if the staff has entered any notes in the staff review notes 1000 field. If so, the notes are inserted into the database server 130 and then the vitals workstation 1740 accesses the readable medium 220 to see if there are any more measurements to be taken.

In the event of an exceptional measurement, the vitals workstation 1740 will insert the measurement into the database server 130 and may defer the donor by enabling the fail 1290 function as best seen in FIG. 13. Additionally, the vitals workstation 1740 can ask additional reflexive questions before deciding whether to defer the donor. If the staff elects to defer the donor, by engaging the fail 1290 function, the vitals workstation 1740 connects to the database server 130, inserts a deferral in the donor deferrals 540, and sets the overall status 1500 of the donor to “failed” in the database server 130. The vitals workstation 1740 also prints a deferral letter stating the reason for deferral and when the donor will be eligible to donate again. The donor's session is ended at the vitals workstation 1740 and the donor center staff chooses the next donor from the queue. However, the staff may elect to take a second reading and enter it into the alternate measurement 1300 fields as shown in FIG. 13. The vitals workstation 1740 uses the process described above until there are no more measurements to be made.

If there are no more measurements, the vitals workstation 1740 enables the pass 1285 function. If not already enabled, the vitals workstation 1740 also enables the fail 1290 function. If the fail 1290 function is engaged, the vitals workstation 1740 will defer the donor as described above. If the pass 1285 function is engaged, the vitals workstation 1740 changes the exam status 1520 of the donor to “passed” in database server 130. At this time, the donor's session at the vitals workstation 1740 ends. If both vitals and review are passed, the overall status 1500 is changed to “ready,” and the donor enters a queue to wait for the donation workstation 1780.

### F. Donation Workstation

When selected by the staff, the donor moves to the location of the donation workstation 1780. By way of overview, the logical progression of the donation workstation 1780 is best seen in FIG. 21. The donation workstation 1780 consists of at least one workstation 100 executing the donation module 254. In this stage of the donation, a staff member is the user of the system. The staff starts the donor's session at the donation workstation 1780 by selecting the next donor in the queue. In one embodiment, the staff uses the donor picture 500 to identify the donor. Next, the staff assigns a donation unit number 1470 for the blood bag to be used in the donation.

The donation workstation 1780 displays a draw screen for the donor center staff to complete while drawing blood. As best seen in FIG. 14, the staff member must enter the donation unit number into the donation unit number 1470 field before the donation can begin. Once entered, the start 1400 function becomes enabled and other fields such as the arm 1455 field, the RBC loss 1435 field, the plasma volume loss 1450 field, the blood volume 1440 field, the reaction 1460 field, the draw codes 1465 field, and the donation annotations 1475 field may be edited. These fields may be engaged at any time after the donation unit number 1470 has been entered into the form. The donation workstation 1780 updates the database server 130 with the changes.

The staff may then engage the start 1400 function to start the blood draw. When this happens, the donation workstation 1780 automatically sets the start time 1430 field as best seen in FIG. 15A. When drawing blood, the donation workstation 1780 disables the start 1400 function and enables the stop 1405 function. When the blood draw is complete, the staff engages the stop 1405 function which sets the stop time 1445 field, disables the stop 1405 function and enables the success 1415 function and the failure 1420 function. When the success 1415 function or the failure 1420 function is engaged, the database server 130 is updated with the status of the blood draw. The session at the donation workstation 1780 is now finished and the overall status 1500 of the donor in the database server 130 is set to “complete.” The donation session then ends and the donor is finished with the donation process.

### G. Management Workstation

The “waiting room function” can be used by donation center management to oversee donor room operations at a management workstation 1760. The users are supervisory staff who manage and monitor donors of the donor center. The waiting room sub-window of the reception window displays all donors who are present for donation and have been registered. In addition to the donor's name, the donors blood type, wait time in minutes, donation type, procedure, and status are also displayed. The donors can be displayed in any order based on user preference.

The user can monitor the activity or progress of the donor in the donor room and maximize timing and donor flow by selecting the order in which the interview, review or physical examination processes occur. Donation statuses are stages of the donation process through which a donor must pass to complete the donation (See FIG. 15E). There are a total of eight donation statuses. Four are representative of a process the donor has completed during the donation process: present, interviewed, examined and ready. The other four statuses represent a final status for the donor or donation; complete, failed, rejected and bailed. The user can determine what step of the donation process the donor is engaged in currently. There is a view option, “only present”, which limits the list to only the donors who are currently undergoing the donation process, removing from the list those donors who have a final donation status (complete, failed, rejected or bailed).

While the description above refers to particular embodiments of the present invention, it will be understood that many modifications may be made without departing from the spirit thereof. The presently disclosed embodiments are therefore to be considered in all respects illustrative and not restrictive.

What is claimed is:

1. A data processing system for processing and managing information of a patient, the system comprising:
a computer having a processor;
an input module adapted to receive information related to the patient;
a communications device; and
a computer readable medium communicatively connected to the processor and adapted to store an editor module capable of being executed on the processor to allow a user to add, edit and update questions to be used by a plurality of software modules stored on the readable medium for processing and managing information related to the patient, the plurality of software modules including a review module adapted to automatically review the information related to the patient.

2. The data processing system of claim 1, wherein the patient is a blood provider and each of the plurality of software modules are adapted to process and manage information related to the blood provider.

3. The data processing system of claim 1, wherein the editor module is further adapted to change at least one of content, appearance and decision logic associated with the questions.

4. The data processing system of claim 2, wherein the plurality of software modules includes at least one of: (i) a registration module adapted to register the blood provider; (ii) an interview module adapted to automatically generate questions to interview the blood provider; (iii) a vitals module adapted to allow a staff member to collect various vital information of the blood provider; (iv) a blood donation module adapted to facilitate drawing blood of the blood provider; and (v) a management module adapted to manage the registration module, the interview module, the review module, the vitals module, and the blood donation module.

5. The data processing system of claim 1, wherein the editor module is further adapted to create multiple types of questions including at least one of: (i) direct questions; (ii) indirect questions; (iii) seasonal questions; and (iv) reflexive questions.

6. The data processing system of claim 1, wherein the editor module is further adapted to at least one of add, edit and update a question based on at least one of: (i) language of the patient; (ii) sex of the patient; (iii) date of expiration of the question; (iv) value of a deferral attribute; and (v) value of a highlight attribute.

7. The data processing system of claim 1, wherein the editor module is further adapted to attach one or more options to the questions, the options including at least one of: (i) rejectable flag; (ii) skippable flag; (iii) alternate form available flag; and (iv) interruptible flag.

8. The data processing system of claim 4, wherein the registration module is further adapted to at least one of: (1) allow the blood provider to self-register; and (2) allow the blood provider to be registered by a staff member.

9. The system of claim 4, wherein the registration module is further adapted to allow the user to input information using a touch-screen input monitor.

10. The system of claim 4, wherein the registration module is further adapted to allow the user to provide identification information using at least one of: (1) a radio frequency information identification reader; (1) a magnetic strip reader; and (3) a biometrics identification reader.

11. The system of claim 4, wherein each of the registration module, the interview module, the review module, the vitals module, the donation module, and the management module, are adapted to be implemented on different workstations wherein each of workstations is communicatively connected to the computer using at least one of: (1) a land-line network; and (2) a wireless network.

12. The system of claim 4, further comprising a database communicatively connected to the computer and adapted to store blood provider information from each of the registration module, the interview module, the review module, the vitals module, the donation module, and the management module.

13. The system of claim 4, wherein the plurality of software modules further includes a web services module adapted to allow the user to interact with each of the registration module, the interview module, the review module, the vitals module, the donation module, and the management module using a web browser.

14. The system of claim 13, wherein the web service module is further adapted to allow the blood provider to at least one of: (1) schedule an appointment for blood donation; and (2) assess his eligibility to donate specific blood components including at least one of red blood cells, platelets, and plasma.

15. The system of claim 4, wherein the registration module is further adapted to prescreen the blood provider to at least one of: (1) reject the blood provider's attempt for blood donation; (2) temporarily defer the blood provider's blood donation while saving blood provider information; (3) report the blood provider information to a regulatory body; and (4) determine eligibility for various donation types by tracking the total accumulative loss of at least one of red blood cells, platelets and plasma.

16. The system of claim 15, wherein the registration module is further adapted to receive information from a third party source to prescreen the blood provider.

17. The system of claim 12, wherein the registration module is further adapted to capture a photograph of the blood provider and the database is further adapted to store the photograph for blood provider identification.

18. The system of claim 4, wherein the plurality of software modules further includes an automated kiosk module adapted to allow the blood provider to self-authenticate.

19. The system of claim 4, wherein the review module is further adapted to provide the user a set of reflexive questions that allows the user to disqualify the blood provider.

20. The system of claim 4, wherein the review module is further adapted to:
receive a handwritten signature from the blood provider using an electronic signature device having a digitizing pad and a stylus; and
recognize the blood provider's signature using an image-processing module.

21. The system of claim 4, wherein the vitals module is further adapted to compare at least one measurement of the blood provider with a range to determine whether the at least one measurement is nominal, impossible or exceptional.

22. The system of claim 4, wherein the donation module is further adapted to use at least one of (1) an electronic scale and (2) a hand-held device to receive information about blood collected from the blood provider.

23. The system of claim 4, wherein the plurality of software modules further includes a lot release module adapted to allow the user to ensure sufficiency of documentation regarding blood donated by the blood provider.

24. The system of claim 4, wherein the management module is further adapted to generate the blood provider room sub-window to display status of the blood provider's blood donation process including at least one of: (1) an overall status; (2) an interview status; and (3) an exam status.

25. The system of claim 12, wherein the plurality of software modules further includes a synchronization manager module adapted to synchronize data stored on at least one of: (1) the database; and (2) one or more mobile database servers, with data processed by at least one of the registration module, the interview module, the review module, the vitals module, the donation module, and the management module.

26. The system of claim 25, wherein the synchronization manager module is further adapted to generate conflict reports based on synchronization of data between various databases and modules.

27. The system of claim 4, wherein the plurality of software modules further includes a workstation manager module adapted to create an additional workstation to implement one or more of the registration module, the interview module, the review module, the vitals module, the donation module, and the management module.

28. The system of claim 27, wherein the workstation manager module is further adapted to assign the additional work station at least one of: (1) a unique network identification; (2) a blood donation center; (3) and a short description.

29. The system of claim 4, wherein the plurality of software modules further includes a drive and site manager module adapted to allow the user to create, modify or select at least one of: (1) a blood donation site; and (2) a blood donation drive.

30. The system of claim 4, wherein the plurality of software modules further includes a user administration module adapted to maintain up-to-date information about authorized users of the system.

31. The system of claim 4, wherein the plurality of software modules further includes a data extraction module adapted to automatically or manually update any blood provider records in a database server.

32. The system of claim 4, wherein the plurality of software modules further includes a blood provider manager module adapted to identify and locate previous blood donations of a repeat blood provider, and to identify when the repeat blood provider becomes ineligible to donate blood.

33. The system of claim 4, wherein the plurality of software modules further includes a resource management module adapted to forecast number of blood providers and equipment necessary for a blood drive.

34. The system of claim 4, wherein the plurality of software modules further includes a sample management module adapted to read bar-coded labels on a tube using a bar-code reader and to determine the content of the tube.

35. A network for processing patient information, the network comprising:
a processor communicatively connected to a plurality of nodes, the plurality of nodes including:
a signature capture node adapted to capture and digitize signature of the patient;
a photo identification node adapted to capture electronic photograph of the patient;
an equipment interface node adapted to capture patient's physiological data;
a lot release module adapted to allow the user to ensure sufficiency of documentation regarding blood donated by the blood provider; and
each of the plurality of nodes adapted to communicate information to and from a database server communicatively connected to the processor.

36. The network of claim 35, further comprising a wireless node adapted to communicate patient information from a handheld device, the patient information including a photograph, date of birth, and other information pertinent to the phlebotomy including at least one of allergy information and information about eligible procedures.

37. The network of claim 35, wherein the equipment interface node is adapted to receive patient's physiological data from at least one of: (i) a weighing machine; (ii) a blood pressure monitor; (iii) a thermometer; and (iv) a pulse monitor.

38. The network of claim 35, wherein the database server is further adapted to store a synchronization module adapted to synchronize data stored on the database server and data from at least one of the signature capture node, the photo identification node, the equipment interface node, and the wireless node.

39. The network of claim 38, wherein the synchronization module further includes a synchronization manager adapted to generate a conflict report based on synchronization of data.

40. The network of claim 35, wherein the database server is further adapted to store a data extraction module adapted to automatically or manually update any blood provider records in the database server.

41. The network of claim 35, wherein the database server comprises a blood provider management module adapted to identify and locate previous blood donations of a repeat blood provider, when the repeat blood provider becomes ineligible to donate blood.

42. The network of claim 35, wherein:
the database server is communicatively connected to an electronic bar-code reader adapted to read bar-code label on a tube; and
the database server comprises a sample management module adapted to receive the bar-code label to determine the content of the tube.

43. A method of processing and managing information of a blood provider, the process comprising:
at least one of: (1) adding questions; (2) editing questions; and (3) updating questions;
storing the questions on the database; and
using the questions to automatically present questions to interview the blood provider, and to review the information of the blood provider.

44. The method of claim 43, further comprising changing at least one of content, appearance and decision logic associated with the questions.

45. The method of claim 43, wherein the questions include at least one of: (i) a direct question; (ii) an indirect question; (iii) a seasonal question; and (iv) a reflexive question.

46. The method of claim 43, further comprising at least one of: (1) adding the questions; (2) editing the questions; and (3) updating the questions based on at least one of: (i) language of the blood provider; (ii) sex of the blood provider; (iii) date of expiration of the question; (iv) value of a deferral attribute; and (v) value of a highlight attribute.

47. The method of claim 43, wherein registering the blood provider further comprises using the questions to self-register the blood provider.

48. The method of claim 43, further comprising:
presenting at least one of the questions to the blood provider on the touch-screen input monitor; and
receiving the blood provider's responses to the using the touch-screen input monitor.
